(19) United States
(12) Patent Application Publication
(10) Pub. No.: US 2025/0272027 A1
(43) Pub. Date: Aug. 28, 2025

(54) METHODS OF OPERATING MEMORY SYSTEM, CONTROLLERS, MEMORY SYSTEMS, AND STORAGE MEDIUMS

(71) Applicant: YANGTZE MEMORY TECHNOLOGIES CO., LTD., Wuhan (CN)

(72) Inventors: Zhuangfei QIAN, Wuhan (CN); Haochiang HSU, Wuhan (CN); Zhe SUN, Wuhan (CN); Weilin LIU, Wuhan (CN); Hua TAN, Wuhan (CN)

(21) Appl. No.: 18/781,651

(22) Filed: Jul. 23, 2024

(30) Foreign Application Priority Data
Feb. 26, 2024 (CN) 202410209432.7

(51) Int. Cl. G06F 3/06

(52) U.S. Cl. CPC G06F 3/0659; G06F 3/0604; G06F 3/0679

(57) ABSTRACT

An example method of operating a memory system includes: setting, to a readable state, part of N channel queues corresponding to a same channel, where the channel queues include read commands received by a controller, addresses of read commands in different channel queues correspond to different memory dies, the readable state indicates that the read commands in the channel queues are allowed to be read, and N is an integer greater than or equal to 2; acquiring a read command in a channel queue in the readable state among the N channel queues; and performing a read operation in a corresponding memory in a memory system according to the acquired read command.

### CROSS-REFERENCE TO RELATED APPLICATIONS

The present application claims the benefit of priority to China Application No. 202410209432.7, filed on Feb. 26, 2024, the content of which is incorporated herein by reference in its entirety.

### TECHNICAL FIELD

The present application relates to the technical field of memories, and in example to methods of operating a memory system, controllers, memory systems, and storage mediums.

### BACKGROUND

In memory products such as a NAND flash and the like, random read performance is an indicator to measure the performance of the memory products.

### SUMMARY

Examples of the present application provide methods of operating a memory system, controllers, memory systems, and storage mediums.

In an aspect, a method of operating a memory system is provided. The method may include setting, to a readable state, part of N channel queues corresponding to a same channel, where the N channel queues comprise read commands received by a controller, addresses comprised in read commands in different channel queues correspond to different memory dies, the readable state indicates that the read commands in corresponding channel queue are allowed to be read, and N is an integer greater than or equal to 2. The method may further include acquiring a read command in a channel queue in the readable state among the N channel queues, and performing a read operation in a corresponding memory in a memory system according to the acquired read command.

In an example, the addresses comprised in the read commands in the channel queues correspond to dies connected to one or more CE pins in the channel.

In an example, the N channel queues include a first channel queue and a second channel queue. Addresses comprised in read commands in the first channel queue correspond to a die connected to a CE pin, whose number belongs to a first number set, in the channel. Addresses comprised in read commands in the second channel queue correspond to a die connected to a CE pin, whose number belongs to a second number set, in the channel.

In an example, setting, to the readable state, part of the N channel queues corresponding to the same channel may include setting, to the readable state, the N channel queues corresponding to the same channel in turn according to time periods.

In an example, setting, to the readable state, the N channel queues corresponding to the same channel in turn according to the time periods may include: within one time period, setting a third channel queue in the N channel queues to a readable state, and setting other channel queues in the N channel queues other than the third channel queue to a non-readable state, where the non-readable state indicates that the read commands in corresponding channel queue are not allowed to be read; and within two adjacent time periods, the channel queues set to the readable state are different.

In an example, the controller includes a readable state register, and N bits in the readable state register correspond to the N channel queues one to one. Within one time period, setting the third channel queue in the N channel queues to the readable state, and setting other channel queues in the N channel queues other than the third channel queue to the non-readable state includes: setting, to a first numerical value, a bit in the readable state register that corresponds to the third channel queue; and setting, to a second numerical value, bits in the readable state register that correspond to other channel queues other than the third channel queue.

In an example, the readable state register is disposed in a flash control unit of the controller; or the readable state register is disposed outside the flash control unit of the controller.

In an example, acquiring a read command in a channel queue in the readable state among the N channel queues includes: reading numerical values of N bits in the readable state register; and reading the read command from the channel queue corresponding to the bit, whose numerical value is the first numerical value, among the N bits.

In an example, before setting, to the readable state, part of the N channel queues corresponding to the same channel, the method further includes: receiving a first instruction. The first instruction indicates enabling of a function for setting part of the N channel queues to the readable state.

In an example, before setting, to the readable state, the N channel queues corresponding to the same channel in turn according to the time periods, the method further includes: receiving a second instruction. The second instruction is for indicating a time duration of the time periods. Setting, to the readable state, the N channel queues corresponding to the same channel in turn according to the time periods includes: according to the time duration of the time periods, setting the N channel queues to the readable state in turn according to the time periods.

In another aspect, a controller is provided. The controller is used in a memory system. The controller includes a micro-controller unit and a flash control unit. The micro-controller unit is configured to set, to a readable state, part of a plurality of channel queues corresponding to a same channel, where the channel queues include read commands received by a controller, addresses comprised in read commands in different channel queues correspond to different memory dies, the readable state indicates that the read commands in corresponding channel queues are allowed to be read, and N is an integer greater than or equal to 2. The flash control unit is configured to acquire a read command in a channel queue in the readable state among the plurality of channel queues; and perform a read operation in a corresponding memory in a memory system according to the acquired read command.

In an example, the addresses comprised in the read commands in the channel queues correspond to dies connected to one or more CE pins in the channel.

In an example, the N channel queues include a first channel queue and a second channel queue; addresses comprised in read commands in the first channel queue correspond to a die connected to a CE pin, whose number belongs to a first number set, in the channel; and addresses comprised in read commands in the second channel queue correspond to a die connected to a CE pin, whose number belongs to a second number set, in the channel.

In an example, the micro-controller unit is configured to set, to the readable state, the N channel queues corresponding to the same channel in turn according to time periods.

In an example, the micro-controller unit is configured to, within one time period, set a third channel queue in the N channel queues to a readable state, and set other channel queues in the N channel queues other than the third channel queue to a non-readable state, where the non-readable state is a state in which the read commands in the channel queues are not allowed to be read; and within two adjacent time periods, the channel queues set to the readable state are different.

In an example, the controller includes a readable state register, and N bits in the readable state register correspond to the N channel queues one to one. The micro-controller unit is configured to set, to a first numerical value, a bit in the readable state register that corresponds to the third channel queue; and set, to a second numerical value, bits in the readable state register that correspond to other channel queues other than the third channel queue.

In an example, the readable state register is disposed in a flash control unit of the controller; or the readable state register is disposed outside the flash control unit of the controller.

In an example, the flash control unit is configured to read numerical values of N bits in the readable state register; and read the read command from the channel queue corresponding to the bit, whose numerical value is the first numerical value, among the N bits.

In an example, the micro-controller unit is further configured to receive a first instruction sent by a host. The first instruction is for indicating enabling of a function for setting the N channel queues to the readable state in turn according to the time periods.

In an example, the micro-controller unit is further configured to receive a second instruction sent by a host. The second instruction is for indicating a time duration of the time periods. The micro-controller unit is configured to, according to the time duration of the time periods, set the N channel queues to the readable state in turn according to the time periods.

Another aspect provides a memory system. The memory system includes a memory and a controller. The controller is configured to set, to a readable state, part of a plurality of channel queues corresponding to a same channel, where the channel queues include read commands received by the controller, addresses comprised in read commands in different channel queues correspond to different memory dies, the readable state indicates that the read commands in corresponding channel queue are allowed to be read, and N is an integer greater than or equal to 2. The controller is further configured to acquire a read command in a channel queue in the readable state among the plurality of channel queues; and perform a read operation in the corresponding memory according to the acquired read commands.

In an example, the addresses comprised in the read commands in the channel queues correspond to dies connected to one or more CE pins in the channel.

In an example, the N channel queues include a first channel queue and a second channel queue; addresses comprised in read commands in the first channel queue correspond to a die connected to a CE pin, whose number belongs to a first number set, in the channel; and addresses comprised in read commands in the second channel queue correspond to a die connected to a CE pin, whose number belongs to a second number set, in the channel.

In an example, the controller is configured to set, to the readable state, the N channel queues corresponding to the same channel in turn according to time periods.

In an example, the controller is configured to, within one time period, set a third channel queue in the N channel queues to a readable state, and set other channel queues in the N channel queues other than the third channel queue to a non-readable state. The non-readable state is a state in which the read commands in the channel queues are not allowed to be read.

Within two adjacent time periods, the channel queues set to the readable state are different.

In an example, the controller includes a readable state register, and N bits in the readable state register correspond to the N channel queues one to one. The controller is configured to set, to a first numerical value, a bit in the readable state register that corresponds to the third channel queue; and set, to a second numerical value, bits in the readable state register that correspond to other channel queues other than the third channel queue.

In an example, the readable state register is disposed in a flash control unit of the controller; or the readable state register is disposed outside the flash control unit of the controller.

In an example, the controller is configured to read numerical values of N bits in the readable state register; and read the read command from the channel queue corresponding to the bit, whose numerical value is the first numerical value, among the N bits.

In an example, the controller is further configured to receive a first instruction sent by a host. The first instruction is for indicating enabling of a function for setting the N channel queues to the readable state in turn according to the time periods.

In an example, the controller is further configured to receive a second instruction sent by a host. The second instruction is for indicating a time duration of the time periods. The controller is configured to, according to the time duration of the time periods, set the N channel queues to the readable state in turn according to the time periods.

In another aspect, a computer-readable storage medium is provided. The computer-readable storage medium stores instructions. The instructions, when running on a controller in a memory system, implement the operation method of a memory system described in any one of the above examples.

### BRIEF DESCRIPTION OF THE DRAWINGS

In order to describe the technical solutions in examples of the present application more clearly, the drawings required to be used in the examples will be simply introduced below. It is apparent that the drawings in the following descriptions are only some examples of the present application. Those of ordinary skill in the art may further obtain other drawings according to these drawings without creative work.

FIG. 1 is a schematic diagram of a computer system provided by an example of the present application;

FIG. 2 is a schematic structural diagram of a memory card involved in the present application;

FIG. 3 is a schematic structural diagram of a solid state disk involved in the present application;

FIG. 4 is a block diagram of a memory according to an example of the present application;

FIG. 5 is a schematic circuit diagram of a memory according to an example of the present application;

FIG. 6 is a side view of a cross section of a memory string according to an example of the present application;

FIG. 7 is a schematic diagram of a correspondence relationship between a controller and a memory;

FIG. 8 is a diagram of a relationship between the average number of working planes and a working current;

FIG. 9 is a diagram of a relationship between the average number of working planes and power consumption of each KIOPS of a memory array;

FIG. 10 is a flow diagram of an operation method of a memory system according to an example of the present application;

FIG. 11 is a schematic division diagram of a channel queue involved in examples of the present application;

FIG. 12 is a schematic diagram of a correspondence relationship between a channel queue and a die involved in examples of the present application;

FIG. 13 is a schematic diagram of a correspondence relationship between another channel queue and a die involved in examples of the present application;

FIG. 14 is a schematic diagram of a correspondence relationship between another channel queue and a die involved in examples of the present application;

FIG. 15 is a flow diagram of an operation method of a memory system according to an example of the present application;

FIG. 16 is a schematic diagram of execution logic of a random read command involved in examples of the present application;

FIG. 17 is a schematic diagram of the controlling of different channel queues for enabling based on time slices involved in the present application;

FIG. 18 is a schematic diagram of a read command acquisition involved in examples of the present application;

FIG. 19 is a schematic diagram of disposing a readable state register involved in examples of the present application;

FIG. 20 is a schematic structural diagram of a controller according to an example of the present application; and

FIG. 21 is a structural block diagram of a memory system according to an example of the present application.

### DETAILED DESCRIPTION

Implementations of the present application are further described in detail below with reference to the drawings.

A computer system provided by examples of the present application may include a host and a memory system. The memory system may include a 3D memory, for example, may be a 3D NAND flash.

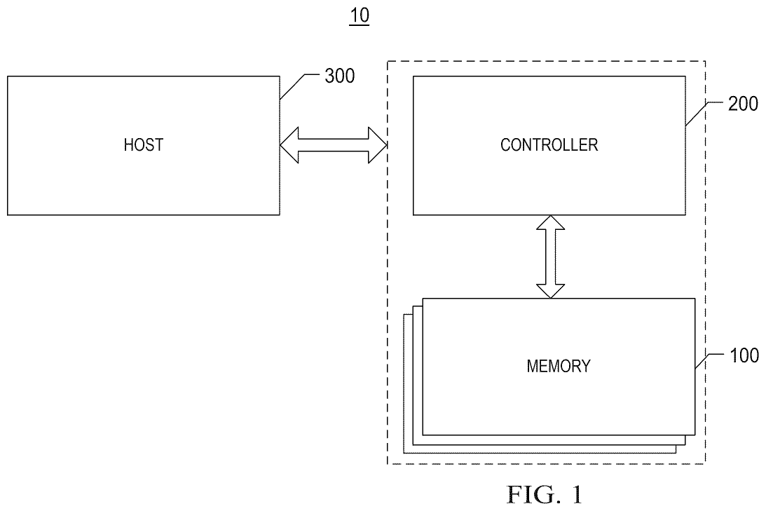

FIG. 1 is a schematic diagram of a computer system provided by an example of the present application. As shown in FIG. 1, the computer system 10 includes one or more memories 100, and a controller 200 coupled to the memory 100 and configured to control the memory 100. The controller 200 may also be referred to as a memory controller.

The controller 200 may be configured to control operations (for example, read, erase, write, and program operations) performed by the memory 100. The controller 200 may further be configured to manage various functions with respect to data stored or to be stored in the memory 100, including, but not limited to, bad-block management, garbage collection, logical-to-physical address translation, wear leveling, etc. In an example, the controller 200 may further be configured to process error correcting codes (ECC) with respect to the data read from or written to the memory 100. The controller 200 may further perform any other suitable functions. For example, the controller may format the memory 100.

The controller 200 may also communicate with an external apparatus according to an example communication protocol. In an example, the controller 200 may communicate with an external apparatus through at least one of various interface protocols. The interface protocols may include a universal serial bus USB protocol, a Multi-Media Card (MMC) protocol, a Peripheral Component Interconnect (PCI) protocol, a PCI Express (PCI-E) protocol, an Advanced Technology Attachment (ATA) protocol, a serial ATA protocol, a parallel ATA protocol, a Small Computer System Interface (SCSI) protocol, an Enhanced Small Drive Interface (ESDI) protocol, an Integrated Drive Electronics (IDE) protocol, a Firewire protocol, etc.

In an example, the controller 200 and the one or more memories 100 may be integrated into various types of electronic apparatuses. The electronic apparatuses may include mobile phones, desktop computers, laptop computers, tablet computers, vehicle computers, gaming consoles, printers, positioning apparatuses, wearable electronic apparatuses, smart sensors, virtual reality (VR) apparatuses, augmented reality (AR) apparatuses, or any other suitable electronic apparatuses having the memories. Under this scenario, as shown in FIG. 1, the computer system 10 further includes a host 300. The controller 200 is coupled to the host 300. The controller 200 may manage data stored in the memory 100, and communicate with the host 300, so as to realize functions of the above-mentioned electronic apparatuses.

In some other examples, the controller 200 and the one or more memories 100 may be integrated into various types of memory devices.

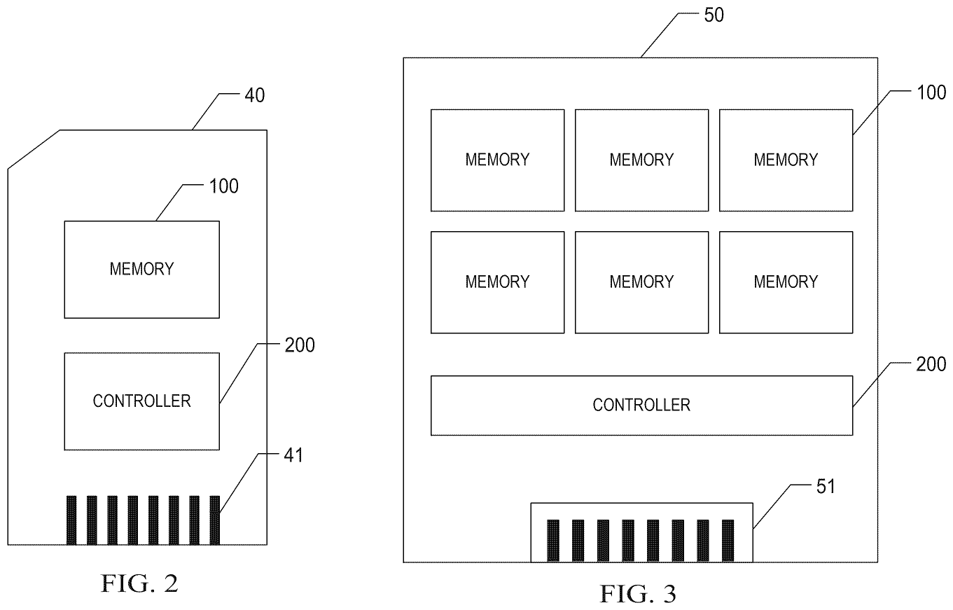

As one example, FIG. 2 is a schematic structural diagram of a memory card involved in the present application. As shown in FIG. 2, the controller 200 and the single memory 100 may be integrated into a memory card 40. The memory card 40 may include a personal computer memory card international association (PCMCIA, PC) card, a compact flash (CF) card, a smart media (SM) card, a memory stick, a multi-media card (MMC), a reduced size MMC (RS-MMC), a micro-MMC, a secure digital (SD) card, a universal flash storage (UFS), etc. As shown in FIG. 2, the memory card 40 may further include a connector 41 coupling the memory card 40 with a host.

As another example, FIG. 3 is a schematic structural diagram of a solid state disk involved in the present application. As shown in FIG. 3, the controller 200 and the plurality of memories 100 may be integrated into a solid state disk (SSD) 50. The solid state disk 50 may further include a connector 51 coupling the solid state disk 50 with a host. A storage capacity and/or operation speed of the solid state disk 50 is greater than a storage capacity and/or operation speed of the memory card 40.

In addition, the memory 100 in FIG. 1 to FIG. 3 may be any memory involved in the examples of the present application, For example, the memory may be a 3D NAND memory. A structure of the memory 100 is explained below.

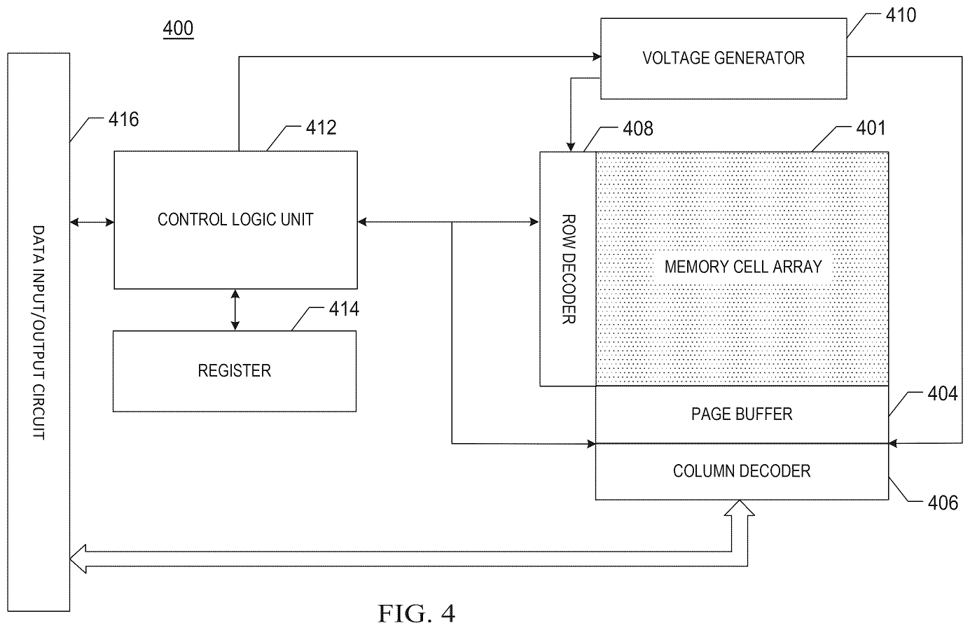

FIG. 4 is a block diagram of a memory according to an example of the present application. Referring to FIG. 4, the memory 400 may include a memory cell array 401, a page buffer 404, a column decoder 406, a row decoder 408, a voltage generator 410, a control logic unit 412, a register 414, and a data input/output circuit 416. It is to be understood that, in some examples, additional peripheral circuits not shown in FIG. 4 may also be included as well.

The page buffer 404 may be configured to read and program (write) data from and to the memory cell array 401 according to a control signal from the control logic unit 412. In one example, the page buffer 404 may store data (write data) to be programmed into a select page of the memory cell array 401. In another example, the page buffer 404 may output read data in a program verification operation to ensure that the data has been properly programmed into a corresponding memory cell coupled to a selected word line of the memory cell array 401. The column decoder 406 may operate in response to the control signal provided by the control logic unit, so as to select one or more NAND memory strings in the memory cell array 401. The row decoder may operate in response to the control signal provided by the control logic unit, and select/unselect a selected row of the memory cell array 401. The row decoder may further be configured to supply a voltage generated from the voltage generator 410 to a selected word line and unselected word line of the memory cell array 401. As described below in detail, the row decoder/word line driver 408 is configured to perform an erase operation on memory cells coupled to one or more selected word lines in the memory cell array 401. The voltage generator 410 may use an external supply voltage or an internal supply voltage to generate various voltages required by the memory, such as program voltages, read voltages, pass voltages, verify voltages, bit line voltages, etc., and combinations thereof.

The control logic unit 412 may be coupled to the voltage generator 410, the page buffer 404, the column decoder 406, the row decoder 408, the data input/output circuit 416, etc., and is configured to control operations of each peripheral circuit. The control logic unit may generate an operation signal in response to a command or control signal from a memory controller. The register 414 may be coupled to the control logic unit 412 and include a state register, a command register, and an address register, so as to store state information, command operation code (OP code), and command address for controlling the operations of each peripheral circuit. The data input/output circuit 416 may be coupled to the control logic unit 412, and act as a control buffer to buffer and relay a control command received from a host (not shown) to the control logic unit 412, and to buffer and relay the state information received from the control logic unit 412 to the host. The data input/output circuit 416 may also be coupled to the column decoder, and act as a data input/output interface and a data buffer to buffer and relay the data to or from the memory cell array 401.

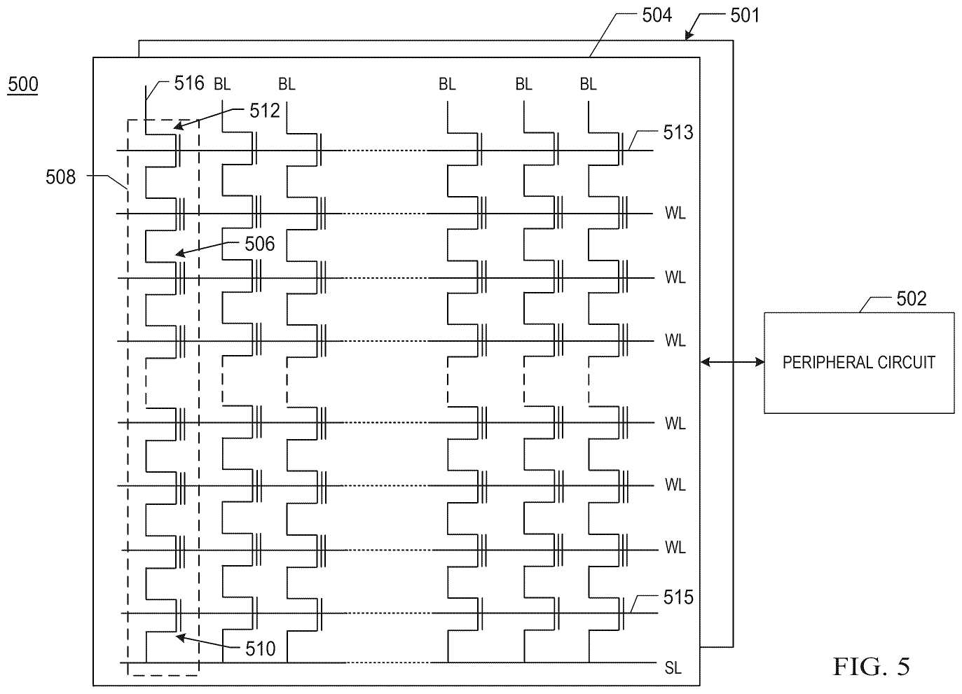

FIG. 5 is a schematic circuit diagram of a memory according to an example of the present application. As shown in FIG. 5, a memory 500 may include a memory cell array device 501, and a peripheral circuit 502 coupled to the memory cell array device 501. The memory cell array device 501 may be a NAND flash memory cell array, where a memory cell 506 is provided in the form of an array of NAND memory strings 508, and each NAND memory string 508 perpendicularly extends above a substrate (not shown). In some implementations, each NAND memory string 508 includes a plurality of memory cells 506 coupled in series and stacked perpendicularly. Each memory cell 506 may be either a floating gate type memory cell that includes a floating gate transistor, or a charge trapping type memory cell that includes a charge trapping transistor. In some implementations, each memory cell 506 is a single level cell (SLC) that has two possible memory states and may store one bit of data. For example, a first memory state “0” may correspond to a first voltage range, and a second memory state “1” may correspond to a second voltage range. In some implementations, each memory cell 506 is a multi-level cell that can store more than one bit of data in more than two memory states. For example, each cell may store two bits (e.g., multi-level cell (MLC)) per cell, store three bits (e.g., triple-level cell (TLC)) per cell, or store four bits (e.g., quad-level cell (QLC)) per cell.

As shown in FIG. 5, each NAND memory string 508 may include at least one source selection transistor 510 at a source end of the memory string, and at least one drain selection transistor 512 at a drain end of the memory string. The source selection transistor 510 and the drain selection transistor 512 may be configured to activate a selected NAND memory string 508 during read and program operations. In some implementations, sources of NAND memory strings 508 in a same block 504 are coupled through a same source line (SL). According to some implementations, the drain selection transistor 512 of each NAND memory string 508 is coupled to a respective bit line 516. In some implementations, each NAND memory string 508 is configured to be selected or unselected by applying a select voltage or an unselect voltage (e.g., 0 V) to the respective drain selection transistor 512 via one or more drain select lines 513 and/or by applying a select voltage or an unselect voltage (e.g., 0 V) to the respective source selection transistor 510 via one or more source select line 515.

As shown in FIG. 5, a memory cell array may include a plurality of blocks. In some implementations, each block 504 is a basic data unit for an erase operation, e.g., all of the memory cells 506 on the same block 504 are erased at the same time.

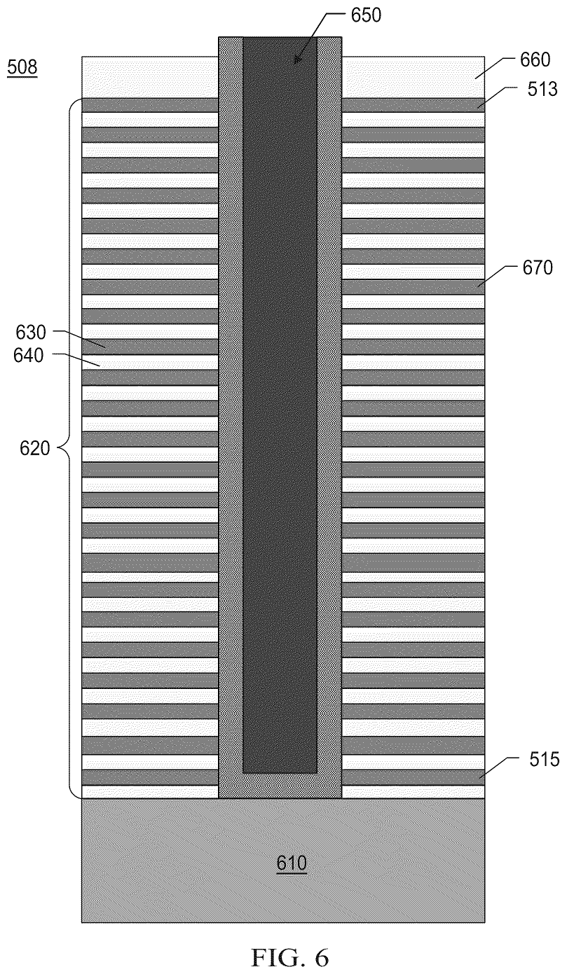

FIG. 6 is a side view of a cross section of a memory string shown by an exemplary example of the present application. Referring to FIG. 6, the memory string 508 may perpendicularly extend through a memory cell stacking layer 620 above a doped semiconductor layer 610. The doped semiconductor layer 610 is coupled to the source line. In some implementations, the doped semiconductor layer 610 is a N-type doped semiconductor layer, and in this case, the doped semiconductor layer 610 may be used as a substrate, e.g., a N-type substrate. In some other implementations, the doped semiconductor layer 610 is a P-type doped semiconductor layer, and in this case, the doped semiconductor layer 610 is a P well in the substrate, and the substrate in this case is a P-type substrate.

The memory cell stacking layer 620 includes gate conductive layers 630 and gate-to-gate dielectric layers 640, which are alternate with each other. The number of pairs of the gate conductive layers 630 and the gate-to-gate dielectric layers 640 in the memory cell stacking layer 620 may determine the number of memory cells in a memory array. The gate conductive layer 630 may include a conductive material. The conductive material includes, but is not limited to, tungsten (W), cobalt (Co), copper (Cu), aluminum (Al), polysilicon, doped silicon, silicide, or any combination thereof. In a possible implementation, each gate conductive layer 630 includes a metal layer, e.g., a tungsten layer. In some implementations, each gate conductive layer 630 includes a doped polysilicon layer. Each gate conductive layer 630 may include a gate surrounding the memory cell, and may horizontally extend at the top of the memory cell stacking layer 620 as a drain select line (DSL) 513, horizontally extend at the bottom of the memory cell stacking layer 620 as a source select line (SSL) 515, or horizontally extend between the DSL and the SSL as a word line (WL) 670.

As shown in FIG. 6, the memory string 508 further includes a channel structure 650 perpendicularly extending through the memory cell stacking layer 620. The channel structure 650 includes a channel hole filled with at least one semiconductor material (e.g., a semiconductor channel) and at least one dielectric material (e.g., a memory film). In some implementations, the semiconductor channel includes silicon (e.g., the memory film). In some implementations, the memory film is a composite dielectric layer including a tunnel layer, a trap layer, and a blocking layer. The channel structure 650 may have a cylindrical shape (e.g., a pillar shape). According to some implementations, the semiconductor channel, the trap layer (also referred to as a storage layer), and the blocking layer are arranged radially from a center toward an outer surface of a pillar in this order. The tunnel layer may include silicon oxide, silicon oxynitride, or any combination thereof. The trap layer may include silicon nitride, silicon oxynitride, or any combination thereof. The blocking layer may include silicon oxide, silicon oxynitride, a high dielectric constant (high-k) dielectric, or any combination thereof. In one example, the memory film may include a composite layer of silicon oxide/silicon oxynitride/silicon oxide.

As shown in FIG. 6, a doped semiconductor layer 660 is stacked on the top of the memory cell stacking layer 620 in the memory string 508; the doped semiconductor layer 660 is also referred to as a bit line contact portion; the doped semiconductor layer 660 is coupled to a bit line for connection; and the doped semiconductor layer 660 is a N-type doped semiconductor layer.

When the doped semiconductor layer 660 is the N-type doped semiconductor layer, an erase operation may be performed on the memory string 508 in a gate-induced drain leakage (GIDL) erase manner through the bit line coupled to the doped semiconductor layer 660 and a DSL coupled to a TSG in the memory string 508. For example, an erase voltage is applied to the bit line coupled to the doped semiconductor layer 660 to apply the erase voltage to the doped semiconductor layer 660, and a voltage less than the erase voltage is applied to the DSL coupled to the TSG in the memory string 508 to form a voltage difference between a gate of the TSG and the doped semiconductor layer 660. The voltage difference causes band-to-band tunneling to occur at a position between the gate of the TSG and the doped semiconductor layer 660, GIDL is generated, and holes in the GIDL moves from the position to a channel of the memory string 508, such that hole injection from the position to the channel of the memory string 508 is realized, causing the potential of the channel to rise. A voltage (referred to as a low voltage, such as 0 V) less than the erase voltage is applied to a word line coupled to each memory cell in the memory string 508, so as to apply the low voltage to the gate of the memory cell. As the potential of the channel of the memory cell increases, and when the voltage difference between the gate of the memory cell and the channel of the memory cell increases, and the voltage difference is greater than a tunneling voltage of the memory cell, a tunneling effect is generated between the channel of the memory cell and the gate of the memory cell due to the voltage difference, such that the holes in the channel of the memory cell are tunneled to the storage layer of the memory cell to remove electrons in the storage layer, thereby realizing the erasing of the memory cell.

In some examples, when the doped semiconductor layer 610 is the N-type doped semiconductor layer, the erase operation may be performed on a substring block in a GIDL erase manner through the source line coupled to the doped semiconductor layer 610 and an SSL coupled to a BSG in the memory string 508. For example, the erase voltage is applied to the source line, a voltage (referred to as a low voltage) less than the erase voltage is applied to the SSL coupled to the BSG to generate the GIDL at a position between a gate of the BSG and the doped semiconductor layer 610, and the holes in the GIDL move toward the channel, such that hole injection from the position to the channel of the memory string 508 is realized, causing the potential of the channel to rise. A low voltage is applied to the word line coupled to each memory cell in the memory string 508; as the potential of the channel of the memory cell increases, and when the voltage difference between the gate of the memory cell and the channel of the memory cell is greater than the tunneling voltage of the memory cell, the holes in the channel are tunneled to the storage layer of the memory cell to eliminate the electrons in the storage layer, thereby realizing the erasing of the memory cell.

Based on this, when the doped semiconductor layer 610 and the doped semiconductor layer 660 both are the N-type doped semiconductor layers, a peripheral circuit may perform the erase operation on the memory string 508 at any end of the memory string 508 in the GIDL erase manner (e.g., a single-end GIDL erase manner), or may perform the erase operation on the memory string 508 at both ends of the memory string 508 respectively in the GIDL erase manner (e.g., a double-end GIDL erase manner).

In some other examples, when the doped semiconductor layer 610 is the P-type doped semiconductor layer, the erase operation is performed on the memory string 508 based on an erase manner of the P-type doped semiconductor layer. For example, the erase voltage is applied to the source line to apply the erase voltage to the P-type doped semiconductor layer; the erase voltage makes the P-type doped semiconductor layer generate holes; a low voltage is applied to the BSG of the memory string 508 and the word line coupled to each memory cell, such that the low voltage is applied to the gate of the BSG and the gate of each memory cell; since the low voltage is less than the erase voltage, the holes move from the P-type doped semiconductor layer to the channel of the memory string 508 to realize hole injection from the P-type doped semiconductor layer to the channel, causing the potential of the channel to rise; and as the potential of the channel of the memory cell increases, and when the voltage difference between the gate of the memory cell and the channel of the memory cell is greater than the tunneling voltage of the memory cell, the holes in the channel are tunneled to the storage layer of the memory cell to eliminate the electrons in the storage layer, thereby realizing the erasing of the memory cell.

Based on this, when the doped semiconductor layer 660 is the N-type doped semiconductor layer, and the doped semiconductor layer 610 is the P-type doped semiconductor layer, double-end erase may be performed on the memory string 508. For example, single-end GIDL erase is performed on one end of the memory string 508 close to the N-type doped semiconductor layer, and erasing based on the P-type doped semiconductor layer is performed on the other end of the memory string 508. Alternatively, single-end erase is performed on the memory string 508. For example, single-end GIDL erase is performed on one end of the memory string 508 close to the P-type doped semiconductor layer, and erasing based on the P-type doped semiconductor layer is not performed on the other end of the memory string 508. Alternatively, single-end GIDL erase is not performed on one end of the memory string 508 close to the P-type doped semiconductor layer, and erasing based on the P-type doped semiconductor layer is performed on the other end of the memory string 508.

Technical details not disclosed in the above memory-related hardware examples may be understood with reference to the descriptions about the computer system examples and method examples of the present application.

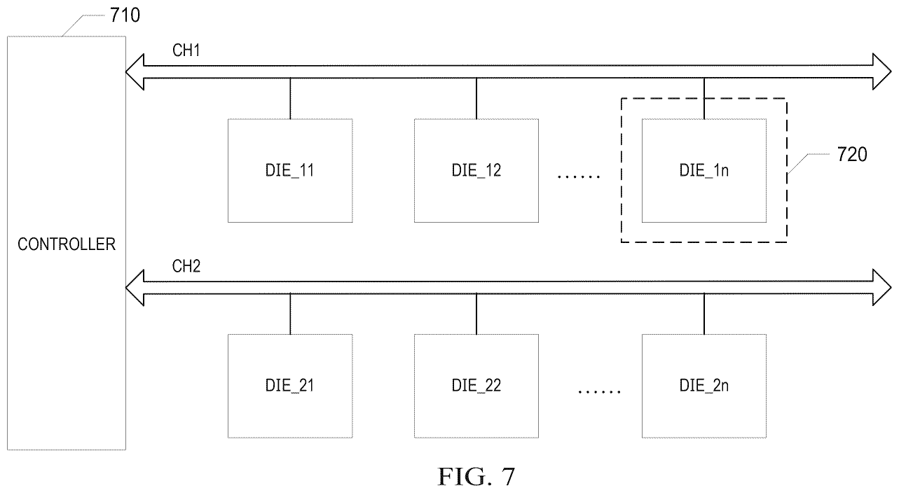

Referring to FIG. 7, it shows a schematic diagram of a correspondence relationship between a controller and a memory. As shown in FIG. 7, in the memory system, the controller 710 manages each memory die 720 in the memory through a plurality of channels (CH).

In FIG. 7, each channel CH corresponds to one group of physical pins in the memory. The group of physical pins may be responsible for receiving and transmitting data and commands. The controller 710 manage the plurality of memory dies 720 respectively through each channel CH. For example, as shown in FIG. 7, the controller 710 manages, through CH1, n memory dies 720 numbered 11-1n, and manages, through CH2, n memory dies 720 numbered 21-2n, where an example that the controller 710 manages the memory dies 720 through two channels is used for description in FIG. 7. In an example, the memory system may also include more memory dies 720. For example, the controller 710 manages the memory dies 720 through three or more channels.

In an example, for each channel, the controller 710 may manage the plurality of memory dies 720 through a plurality of Chip Enables (CE), and each CE may correspond to one or more memory dies.

In a random read operation solution, the controller performs random read operations based on a channel queue (CH Queue). In an example, in the memory system, each channel is correspondingly provided with one channel queue. After receiving a read command, the controller first adds the read command to the corresponding channel queue according to a channel corresponding to an address comprised in the read command, and extracts and performs the read command from each channel queue when performing the read command. Through the above solution, parallel processing may be performed on the read commands corresponding to the plurality of channels.

In the process of the random read operations, the addresses comprised in the read commands are random, for example, the read commands are dispersed to each die for execution. Due to limitations such as power consumption, the number of the read commands simultaneously performed is limited, there are more dies parallelly performing the random read operations, and there are fewer planes for executing work in each die. For a memory product, typically the larger the capacity, the larger the number of dies included in the product, and the larger the number of dies concurrently performing the random read operations; and accordingly, the number of the planes for executing work in each die is fewer, and the energy efficiency of the memory product is lower. The following cases exist: when the number of channels is the same, the energy efficiency of the large-capacity memory product (there are more dies corresponding to each channel) is lower than the energy efficiency of the small-capacity memory product (there are fewer dies corresponding to each channel).

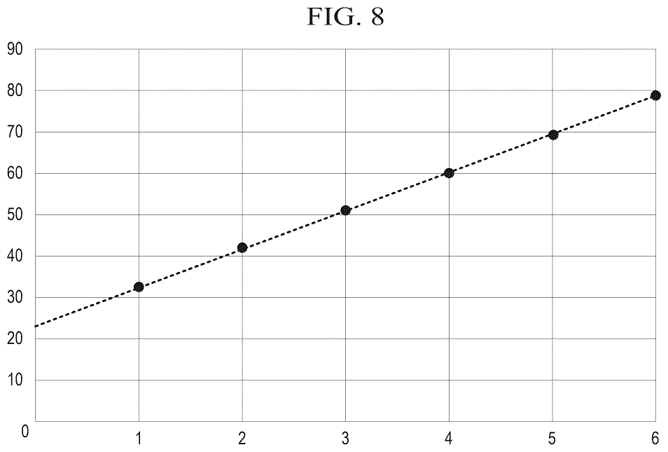

In an example, for example, FIG. 8 shows a diagram of a relationship between the average number of working planes and a working current. In an example, FIG. 8 shows a relationship between the average number of working planes in each die of a memory array and a working current of the memory array during the random read operations. A horizontal coordinate in FIG. 8 is the average number of working planes in each die of the memory array, and a longitudinal coordinate is the working current of the memory array. From FIG. 8, it can be seen that, although the relationship between the average number of working planes in each die of the memory array and the working current of the memory array is linear, the memory array has a fee for start. For example, the dies in the memory array generate certain currents whenever being started.

In combination with FIG. 8, during the random read operations, a formula of power consumption k for the memory array to reach 1K input/output operations per second (KIOPS) may be shown as follows:

$$k = \frac{{ICC}_{1 * n} * VCC}{4 * n * \frac{1024}{t} * 1 / 4}$$

The unit of k is mW/KIOPS, which indicates the number of milliwatts to achieve one thousand read/write operations per second; ICC indicates a working current of the memory array; VCC indicating a working voltage of the memory array; n indicates the average number of working planes of each die in the memory array; and during the random read operations, total power consumption of the memory array may be indicated through k*target random read performance (one thousand random read operations per second).

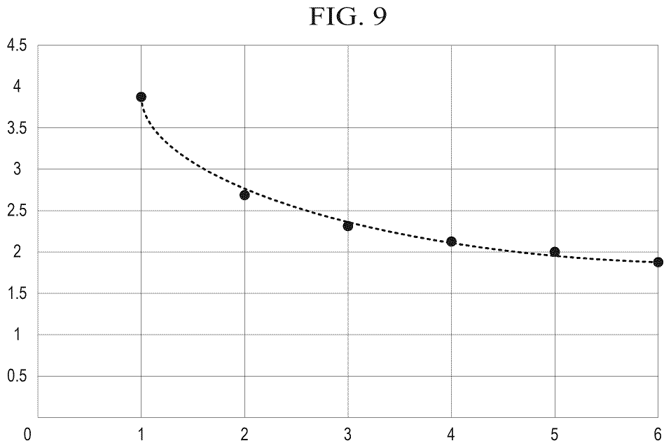

Referring to FIG. 9, it shows a diagram of a relationship between the average number of working planes and the power consumption of each KIOPS of the memory array. In an example, FIG. 9 shows a relationship between the average number of working planes in each die and the power consumption of each KIOPS of the memory array during the random read operations. A horizontal coordinate in FIG. 9 is the average number of working planes in each die of the memory array, and a longitudinal coordinate is the number of milliwatts per second in which the storage array performs one thousand read/write operations. In combination with FIG. 8 and the above formula, as shown in FIG. 9, as the average number of working planes in each die continues to increase, the number (e.g., the k in the above-mentioned formula) of milliwatts to achieve one thousand read/write operations per second gradually decreases. For example, the more the average number of working planes in each die, the better the energy efficiency of the storage array.

Based on the above-mentioned principle, solutions shown in subsequent examples in the present application provide a new operation method of a memory system. The number of dies parallelly performing the random read operations can be controlled in a random read operation scenario, such that the number of working planes in each die parallelly performing random read operations is increased, so as to improve the energy efficiency of the memory array.

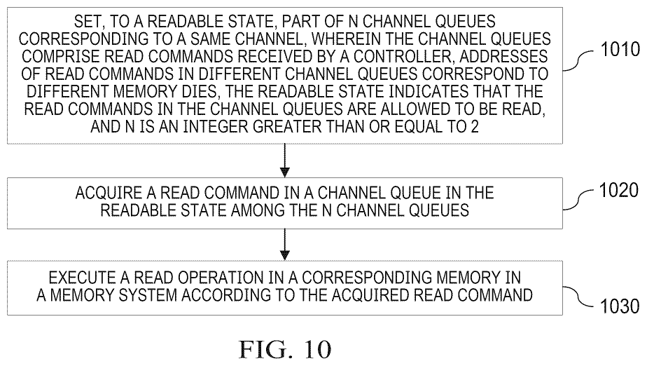

Referring to FIG. 10, it is a flow diagram of an operation method of a memory system according to an example of the present application. The memory system may include a controller and a memory. The operation method of a memory system may be performed by the controller in the memory system. As shown in FIG. 10, the method may include the following operations.

Operation 1010, setting, to a readable state, part of N channel queues corresponding to a same channel. The channel queues include read commands received by a controller, addresses comprised in read commands in different channel queues correspond to different memory dies, the readable state indicates that the read commands in the channel queues are allowed to be read, and N is an integer greater than or equal to 2.

In the examples of the present application, the controller may manage the dies in the memory through one or more channels. For each channel, two or more (e.g., N) channel queues may be provided, and each channel queue corresponds to a part of the dies managed by the channel. In the random read operation scenario, every time the controller receives one read command sent by a host, the read command may be added to one corresponding channel queue according to the die corresponding to the address. At a same moment, part (which may be one or more) of more than N channel queues corresponding to one channel are set to the readable state, and other channels are not set to the readable state (e.g., may be set to a non-readable state). For example, at the moment, the read commands in the part of the N channel queues of the one channel are allowed to be read. In an example, the read commands in the rest of the channel queues (e.g., channel queues set to the non-readable state) are not allowed to read.

The operation of setting a certain channel queue to the readable state may also be referred to as performing enabling on the channel queue, or referred to as enabling the channel queue.

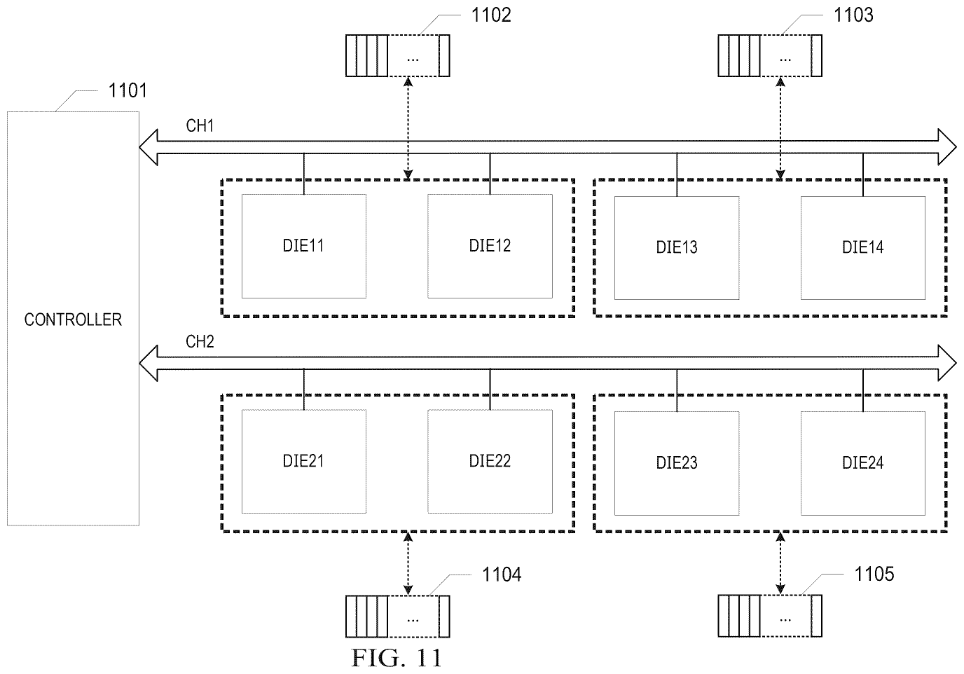

For example, referring to FIG. 11, it shows a schematic division diagram of a channel queue involved in examples of the present application. As shown in FIG. 11, the controller 1101 manages 4 dies in the memory respectively through two channels (CH1 and CH2), and each channel has two channel queues, where the CH1 corresponds to the channel queue 1102 and the channel queue 1103; the CH2 corresponds to the channel queue 1104 and the channel queue 1105; the channel queue 1102 is used for buffering the read commands corresponding to the die11 and die 12 in the CH1; the channel queue 1103 is used for buffering the read commands corresponding to the die13 and die14 in the CH1; the channel queue 1104 is used for buffering the read commands corresponding to the die21 and die22 in the CH2; and the channel queue 1105 is used for buffering the read commands corresponding to the die23 and die24 in the CH2. In the random read operation scenario, at a certain moment A, the channel queue 1102 corresponding to the CH1 and the channel queue 1104 corresponding to the CH2 are set to the readable state, and the channel queue 1103 corresponding to the CH1 and the channel queue 1105 corresponding to the CH2 are set to the non-readable state.

FIG. 11 is exemplarily described only with an example that a memory system includes two channels, each channel corresponds to two channel queues, and each channel queue corresponds to two dies. In an example, the memory system may include a single channel, or may also include three or more channels; each channel may also correspond to three or more channel queues; and each channel queue may correspond to one die, or may also correspond to three or more dies. For example, in the examples of the present application, the number of the channels in the memory system, the number (e.g., N) of the channel queues corresponding to each channel, and the number of the dies corresponding to each channel queue are not limited as shown in FIG. 11.

The above-mentioned operation 1010 may be performed by a micro-controller unit in the memory.

Operation 1020, acquiring a read command in a channel queue in the readable state among the N channel queues.

At a certain moment, when the controller in the memory system performs the read commands, the read commands may be acquired from the channel queues, which are in the readable state, in the N channel queues corresponding to each channel, and for the channels not in the readable state, the read commands therein are not acquired at the moment.

For example, in FIG. 11, at the moment A the controller may acquire the read commands respectively from the channel queue 1102 and the channel queue 1104. In an example, the read commands in the channel queue 1103 and the channel queue 1105 are not acquired at the moment A.

Operation 1030, performing a read operation in a corresponding memory in a memory system according to the acquired read command.

After the controller acquires the read command from the channel queues, the read operation may be performed in the corresponding memory in the memory system, e.g., the read command are performed by the dies corresponding to the read command.

The above-mentioned operation 1020 and operation 1030 may be performed by a flash control unit in the memory.

In conclusion, by means of the solutions shown in the above-mentioned examples of the present application, N channel queues for temporarily storing the read commands are set for each channel in the memory; the addresses comprised in read commands in different channel queues correspond to different memory dies; in the process of performing the random read operation, part of the N channel queues corresponding to the same channel are set to the readable state; the readable state indicates that the read commands in the channel queues are allowed to be read; and when the read commands are performed, the controller acquires a read command in a channel queue in the readable state among the N channel queues, and performs the read operation in the corresponding memory in the memory system according to the acquired read command. By means of the above-mentioned solution, part of the dies in each channel of the memory may be controlled to perform the random read operation at the same time, and the rest of the dies do not perform the random read operation within the time, such that the number of dies parallelly performing random read operations may be reduced, the number of planes working simultaneously in each die is increased, the energy efficiency of the memory is improved, and the impact of power consumption on random read performance is reduced, thereby improving the random read performance of the memory.

Based on the solutions shown in the above-mentioned examples, in an example, at a certain moment, for each channel, the read commands in the rest of the channel queues in the channel aside from channel queues set to the readable state may also be allowed to be read when a pre-specified condition is met. For example, the pre-specified condition may include: in the channel queues corresponding to the current channel, no read command exists in the channel queues set to the readable state. For example, for a certain channel, if, at a certain moment, no read command exists in the channel queues corresponding to the channel that are set to the readable state, but the read commands exist in the channel queues that are set to the non-readable state/not set to the readable state. In this case, the controller may also acquire the read commands from the channel queues that are set to the non-readable state/not set to the readable state, such that the random read operation is prevented from being unable to be performed on the channel at the moment, so as to guarantee the performance of the random read operation.

For example, still using FIG. 11 as an example, at the moment A, when the read commands exist in the channel queue 1102, the controller does not acquire the read commands in the channel queue 1103; when the read commands exist in the channel queue 1104, the controller does not acquire the read commands in the channel queue 1105; if at the moment A, no read command exists in the channel queue 1102, and the read commands exist in the channel queue 1103, the controller may acquire the read commands exist in the channel queue 1103; and accordingly, if, at the moment A, no read command exists in the channel queue 1104, and the read commands exist in the channel queue 1105, the controller may acquire the read commands in the channel queue 1105.

Based on the solution shown in the above-mentioned examples, in an example, the addresses comprised in the read commands in the channel queues correspond to dies connected to one or more CE pins in the channel.

One CE pin in the memory system may be connected to one or more dies, and the controller may select or unselect the dies through the CE pin. In the examples of the present application, the dies corresponding to the channel queue may be divided by using the CE pin as granularity. For example, each channel queue may correspond to one or more CE pins, and the dies connected to the one or more CE pins are the dies corresponding to the channel queue.

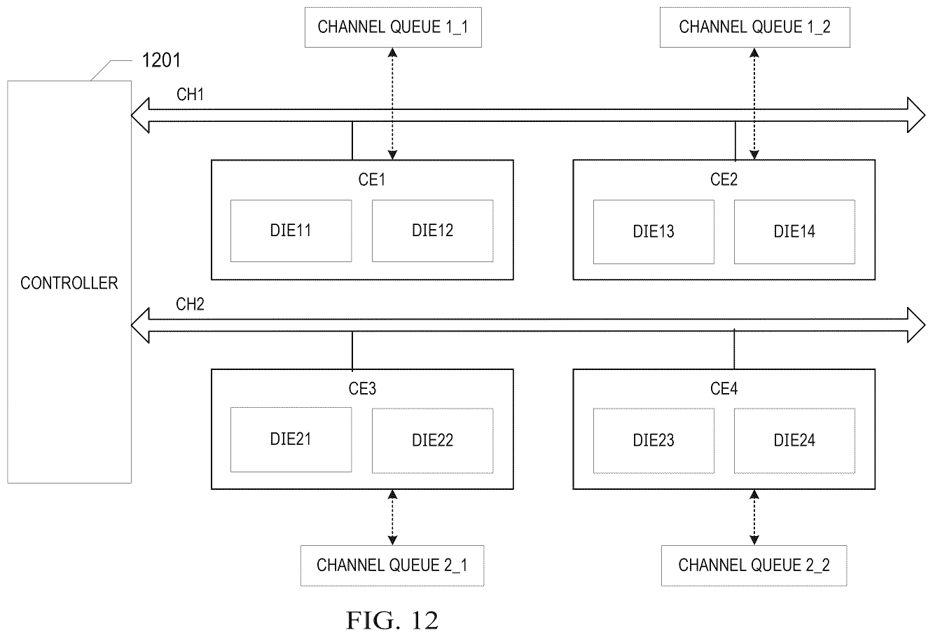

For example, referring to FIG. 12, it shows a schematic diagram of a correspondence relationship between channel queues and dies involved in examples of the present application. As shown in FIG. 12, the controller 1201 manages 8 dies through four CEs, where the CE1 is connected to the die11 and the die12; the CE2 is connected to the die13 and the die14; the CE3 is connected to the die21 and the die22; the CE4 is connected to the die23 and the die24, where the CE1 and the CE2 correspond to the channel CH1 in the memory system, and the CE3 and the CE4 correspond to the channel CH2 in the memory system; the addresses comprised in the read commands in the channel queue 1_1 corresponding to the CH1 correspond to the die11 and the die12, which are connected to the CE1; the addresses comprised in the read commands in the channel queue 1_2 corresponding to the CH1 correspond to the die13 and the die14, which are connected to the CE2; the addresses comprised in the read commands in the channel queue 2_1 corresponding to the CH2 correspond to the die21 and the die22, which are connected to the CE3; and the addresses comprised in the read commands in the channel queue 2_2 corresponding to the CH2 correspond to the die23 and the die24, which are connected to the CE4.

In the above-mentioned examples, the dies corresponding to each channel queue in one channel are divided by using the CE pin as granularity, such that the controller can manage the random read operations of the dies under different CE pins more conveniently.

Based on the solution shown in the above-mentioned examples, in an example, the N channel queues include a first channel queue and a second channel queue; addresses comprised in read commands in the first channel queue correspond to a die connected to a CE pin, whose number belongs to a first number set, in the channel; and addresses comprised in read commands in the second channel queue correspond to a die connected to a CE pin, whose number belongs to a second number set, in the channel.

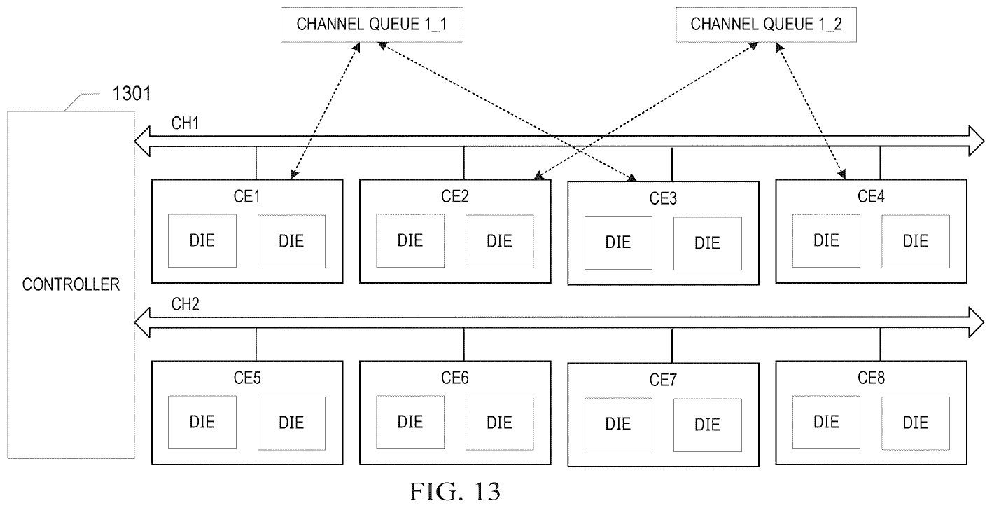

In the above-mentioned examples, the plurality of channel queues corresponding to the same channel in the memory system may respectively correspond to the dies connected to the CE pins with different numbers. For example, referring to FIG. 13, it shows a schematic diagram of a correspondence relationship between another channel queue and a die involved in examples of the present application. As shown in FIG. 13, the controller 1301 manages 16 dies through eight CEs (CE1 to CE8), and each CE is connected to two dies, where the CE1 to the CE4 correspond to the channel CH1 in the memory system, and the CE5 to the CE8 correspond to the channel CH2 in the memory system. Using four CEs corresponding to the CH1 as an example, the addresses comprised in the read commands in the channel queue 1_1 corresponding to the CH1 correspond to the dies connected to the CE pins of a set {CE1, CE3} (whose numbers are odd) in the CH1; and the addresses comprised in the read commands in the channel queue 1_2 corresponding to the CH1 correspond to the dies connected to the CE pins of a set {CE2, CE4} (whose numbers are even) in the CH1.

The solution shown in FIG. 13 is described only with an example that each channel corresponds to two channel queues, and the two channel queues respectively correspond to an odd-numbered CE pin and an even-numbered CE pin.

In an example, in the solution shown in FIG. 13, corresponding CE pins may also be assigned to two channel queues of the CH1 in other manners. For example, in FIG. 13, the addresses comprised in the read commands in the channel queue 1_1 may also correspond to the dies connected to the CE pins numbered {CE1, CE2} in the CH1, and the addresses comprised in the read commands in the channel queue 1_2 may also correspond to the dies connected to the CE pins numbered {CE3, CE4} in the CH1.

Alternatively, in the solution shown in FIG. 13, the CH1 man also correspond to more channel queues, and each channel queue may correspond to more or less CE pins. For example, the CH1 may correspond to four channel queues, which respectively are the channel queue 1_1, the channel queue 1_2, the channel queue 1_3, and the channel queue 1_4, where the addresses comprised in the read commands in the channel queue 1_1 may correspond to the die connected to the CE pin numbered {CE1} in the CH1; the addresses comprised in the read commands in the channel queue 1_2 may correspond to the die connected to the CE pin numbered {CE2} in the CH1; the addresses comprised in the read commands in the channel queue 1_3 may correspond to the die connected to the CE pin numbered {CE3} in the CH1; and the addresses comprised in the read commands in the channel queue 1_4 may correspond to the die connected to the CE pin numbered {CE4} in the CH1.

Based on the solution shown in the above-mentioned examples, in another example, each channel queue may directly correspond to the die in the corresponding channel, for example, directly corresponds to one or more numbered dies in the corresponding channel.

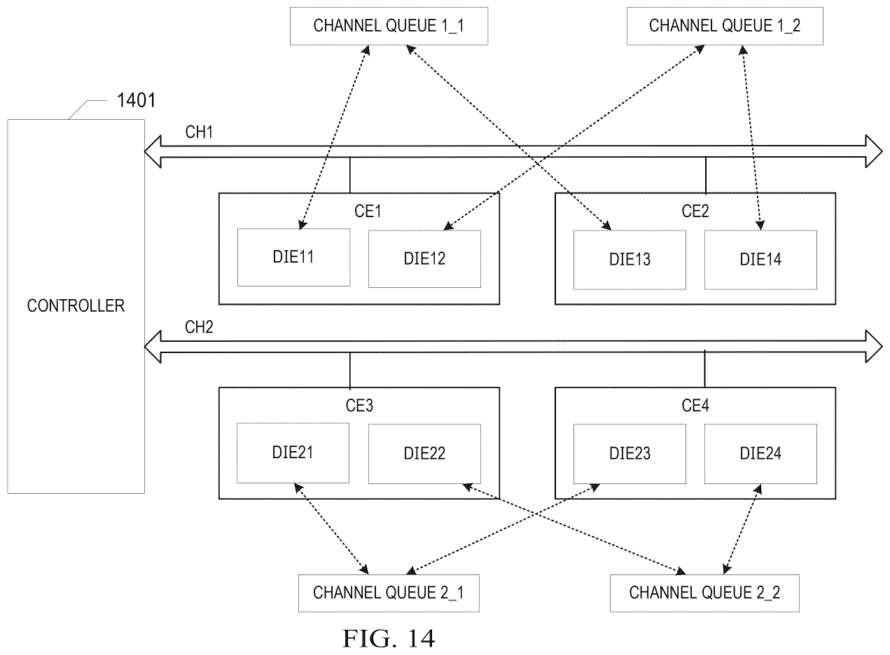

For example, referring to FIG. 14, it shows a schematic diagram of a correspondence relationship between another channel queue and a die involved in examples of the present application. As shown in FIG. 14, the controller 1401 manages 8 dies through four CEs, where the CE1 is connected to the die11 and the die12; the CE2 is connected to the die13 and the die14; the CE3 is connected to the die21 and the die22; the CE4 is connected to the die23 and the die24, where the CE1 and the CE2 correspond to the channel CH1 in the memory system, and the CE3 and the CE4 correspond to the channel CH2 in the memory system; the addresses comprised in the read commands in the channel queue 1_1 corresponding to the CH1 correspond to the die11 connected to the CE1 and the die13 connected to CE2; the addresses comprised in the read commands in the channel queue 1_2 corresponding to the CH1 correspond to the die12 connected to the CE1 and the die 14 connected to CE2; the addresses comprised in the read commands in the channel queue 2_1 corresponding to the CH2 correspond to the die21 connected to the CE3 and the die23 connected to the CE4; and the addresses comprised in the read commands in the channel queue 2_2 corresponding to the CH2 correspond to the die22 connected to the CE3 and the die24 connected to the CE4.

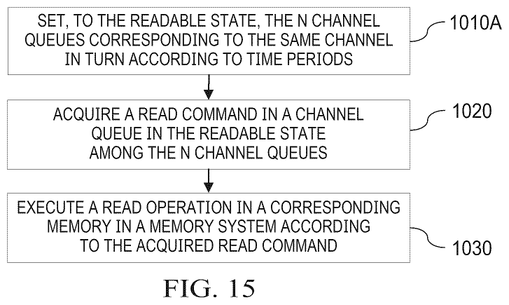

Based on the solution shown in the above-mentioned examples, referring to FIG. 15, it is a flow diagram of an operation method of a memory system according to an example of the present application. As shown in FIG. 15, the above-mentioned operation 1010 may be implemented as operation 1010a.

Operation 1010a, setting, to the readable state, the N channel queues corresponding to the same channel in turn according to time periods.

In the examples of the present application, for the N channel queues in one channel, in order to prevent the fact that read commands in part of the channel queues are performed while the read commands in the rest of the channel queues are never performed, the N channel queues may be set to the readable state in turn according to time periods. For example, within one time period, part of the N channel queues are set to the readable state, and the rest of the channel queues are not set to the readable state (for example, the other part of the channel queues may be set to the non-readable state, or the other part of the channel queues are not set to a corresponding state); and within a next time period, the other part of the N channel queues are set to the readable state, and the rest part of the channel queues are not set to the readable state.

Different time periods may have a same time duration, for example, may both 0.1 seconds or 0.5 seconds; alternatively, different time periods may have different time durations. For example, for two adjacent time periods, a time duration of the first time period may be 0.5 s, and the duration of the second time period may be 0.8 s.

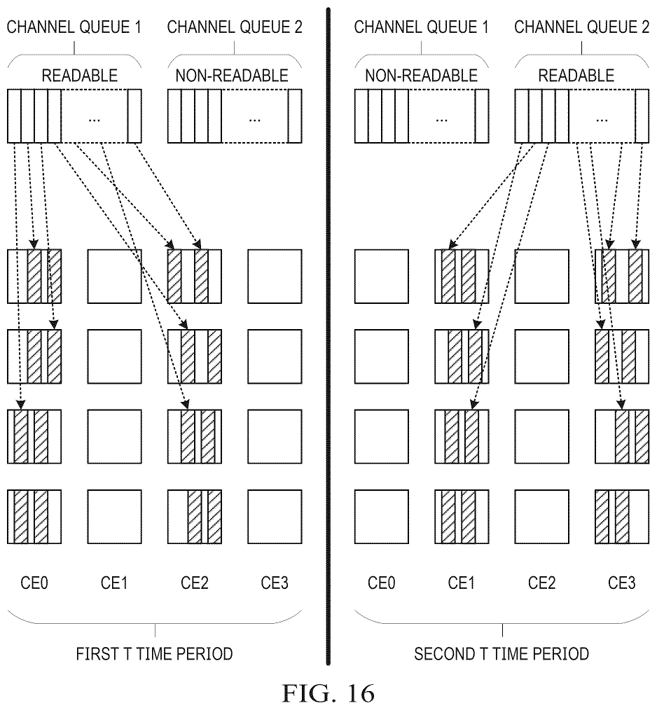

For example, referring to FIG. 16, it shows a schematic diagram of execution logic of a random read command involved in examples of the present application. As shown in FIG. 16, one channel in the memory system corresponds to two channel queues, which respectively are a channel queue 1 and a channel queue 2. The channel corresponds four CEs (numbered CE0 to CE3), and each CE is connected to 4 dies, where the CE0 and CE2 correspond to the channel queue 1, and the CE1 and CE3 correspond to the channel queue 2.

Within a first T time period, the channel queue 1 is set to the readable state, the channel queue 2 is set to the non-readable state, and in this case, the controller acquires read commands in the channel queue 1, and assigns the acquired read commands to the dies connected to the CE0 and the CE2 according to addresses, so as to perform the random read operation in the dies connected to the CE0 and the CE2; within the first T time period, the CE1 and the CE3 do not receive the read commands, such that the random read operation is not performed, and in this case, if there are no other operations in the dies corresponding to the CE1 and the CE3, no work may be done, so as to save power consumption.

Within a second T time period, the channel queue 2 is set to the readable state, the channel queue 1 is set to the non-readable state, and in this case, the controller acquires read commands in the channel queue 2, and assigns the acquired read commands to the dies connected to the CE1 and the CE3 according to addresses, so as to perform the random read operation in the dies connected to the CE1 and the CE3; within the second T time period, the CE0 and the CE2 do not receive the read commands, such that the random read operation is not performed, and in this case, if there are no other operations in the dies corresponding to the CE0 and the CE2, no work may be done, so as to save power consumption.

Through execution logic of the read commands shown in FIG. 16, when the performance (KIOPS) of the memory system performing random read operations is unchanged, compared with the solution in which the dies in the four CEs simultaneously receive the read commands, in the solution shown in the examples of the present application, within one time period, the number of the read commands assigned to part of the dies in the memory system can be increased (doubled in FIG. 16), which means that, in the dies parallelly performing the read commands, the average number of working planes in each die is increased, such that the energy efficiency of the memory system during the execution of random read operations can be improved.

For example, in the solution shown in the above-mentioned examples of the present application, through the scheduling of an I/O during the random read operation by firmware (FW), the division of an entire disk (e.g., the entire disk is divided through the CE) is equivalent to the use of a large-capacity memory product as two or more small-capacity memory products, so as to obtain the energy efficiency similar to the small-capacity memory products, thereby avoiding the problem of the random read performance limited by power consumption.

The solution shown in the above-mentioned examples of the present application may be implemented by the controller, which may limit the number of the parallel dies during Random Read (RR), and in implementations may be based on the design of a CH queue, for example, an original CH queue is split into two portions, which are respectively associated with physical dies connected to the CEs numbered odd and even, then managed based on time slices, and alternately enabled. Using the management mode as an example, one 15.36 TB system product may be equivalent to two 7.68 TB system products, and the energy efficiency of random read is improved based on this. Furthermore, the number of split CH queues may also be increased through more refined management to further improve the energy efficiency of random read of the system product. For example, the above-mentioned solution may realize higher theoretical RR performance under specified power consumption, or may reduce the power consumption of the memory system under specified RR performance.

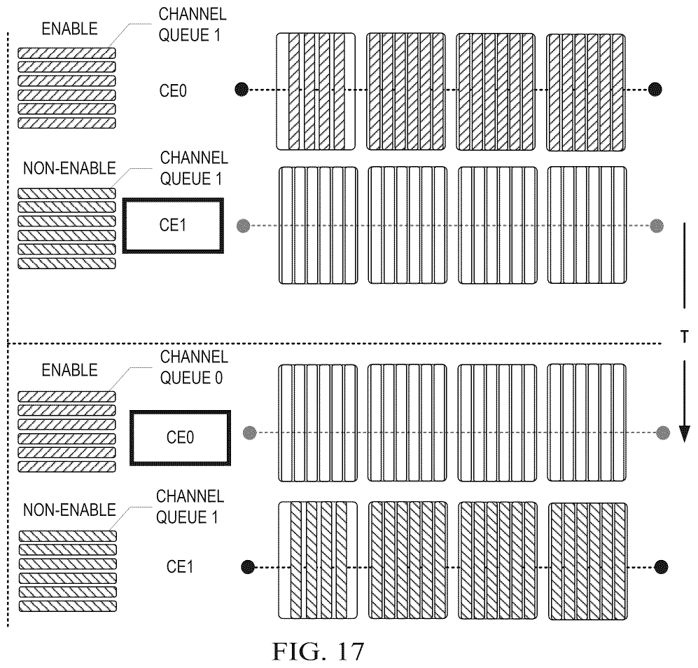

In the solution of setting the single channel queue for each channel, from statistical results, the number of the read commands received by each die is similar, causing various read commands within one time period to be relatively evenly assigned to all the dies of the memory system, and thus resulting in the low average number of working planes on each die. Referring to FIG. 17, it shows a schematic diagram of the controlling of different channel queues for enabling based on time slices involved in the present application. As shown in FIG. 17, according to the solution shown in the above-mentioned examples of the present application, the single CH queue is associated according to the parity of CE numbers, and is split into the channel queue 0 and the channel queue 1. The FW further distributes, according to original behavior logic, a read command to the channel queue corresponding to a physical address to which the read command belongs, but enables one channel queue at the same time. The other channel queue is then enabled after threshold time T is exceeded, and so on, thereby obtaining higher energy efficiency, such that the theoretical power consumption of the large-capacity memory product under the same performance is equivalent to the theoretical power consumption of the small-capacity memory product.

Based on the solution shown in the above-mentioned examples, in an example, setting, to the readable state, the N channel queues corresponding to the same channel in turn according to the time periods includes: within one time period, setting a third channel queue in the N channel queues to a readable state, and setting other channel queues in the N channel queues other than the third channel queue to a non-readable state, where the non-readable state is a state in which the read commands in the channel queues are not allowed to be read; and within two adjacent time periods, the channel queues set to the readable state are different.

The third channel queue may be one of the N channel queues, or the third channel queue may also be the plurality of channel queues in the N channel queues (in this case, the number of the third channel queues is less than N). For example, in the examples of the present application, within each time period, one or part of the N channel queues are set to the readable state; within the time period, the rest of the channel queues are set to the non-readable state; within two continuous time periods, the same channel queue is not set to the readable state.

The third channel queue here may refer to any one or part of the N channel queues.

For example, assuming that one channel corresponds to the channel queue 1 and the channel queue 2, within the 1st time period, the channel queue 1 is set to the readable state, and the channel queue 2 is set to the non-readable state; within the 2nd time period, the channel queue 1 is set to the non-readable state, and the channel queue 2 is set to the readable state; and within the 3rd and 4th time periods, state settings of the 1st time period and the 2nd time period are recycled.

For another example, assuming that one channel corresponds to the channel queue 1, the channel queue 2, the channel queue 3, within the 1st time period, the channel queue 1 is set to the readable state, and the channel queues 2 and 3 are set to the non-readable state; within the 2nd time period, the channel queue 2 is set to the readable state, and the channel queues 1 and 3 are set to the non-readable state; and within the 3rd time period, the channel queue 3 is set to the readable state, and the channel queues 1 and 2 are set to the non-readable state; and within the 4th to 6th time periods, state settings of the 1st to 3rd time periods are recycled.

Based on the solution shown in the above-mentioned examples, in an example, the controller includes a readable state register, and N bits in the readable state register correspond to the N channel queues one to one. Within one time period, setting the third channel queue in the N channel queues to the readable state, and setting other channel queues in the N channel queues other than the third channel queue to the non-readable state includes: setting, to a first numerical value, a bit in the readable state register that corresponds to the third channel queue; and setting, to a second numerical value, bits in the readable state register that correspond to other channel queues other than the third channel queue.

In the examples of the present application, the controller may be provided with a readable state register. For the N channel queues corresponding to one channel, the readable state register may have N bits, which are used for indicating whether the N channel queues are in the readable state or the non-readable state at the current moment, thereby realizing the setting of the readable state of the plurality of channel queues for the same channel in the controller.

In the above-mentioned readable state register, each channel may correspond to independent N bits. For example, a channel 1 corresponds to 2 channel queues, and the channel 1 corresponds to a bit 0 and a bit 1 in the readable state register, where a numerical value of the bit 0 indicates that the 1st channel queue in the channel 1 is in the readable state/non-readable state, and a numerical value of the bit 1 indicates that the 2nd channel queue in the channel 1 is in the readable state/non-readable state. Accordingly, a channel 2 also corresponds to 2 channel queues, and the channel 2 corresponds to a bit 2 and a bit 3 in the readable state register, where a numerical value of the bit 2 indicates that the 1st channel queue in the channel 2 is in the readable state/non-readable state, and a numerical value of the bit 3 indicates that the 2nd channel queue in the channel 2 is in the readable state/non-readable state. In this case, the number of the channel queues corresponding to different channels may be the same or different.

Alternatively, when the memory system includes the plurality of channels, and the number N of the channel queues corresponding to each channel is the same, in the above-mentioned readable state register, the plurality of channels may share the N bits. For example, the channel 1 corresponds to 2 channel queues, and the channel 2 corresponds to 2 channel queues; the bit 0 in the readable state register corresponds to the 1st channel queue in the channel 1 and the 1st channel queue in the channel 2. For example, the numerical value of the bit 0 indicates that the 1st channel queue in the channel 1 and the 1st channel queue in the channel 2 are in the readable state/non-readable state; and accordingly, the bit 1 in the readable state register corresponds to the 2nd channel queue in the channel 1 and the 2nd channel queue in the channel 2. For example, the numerical value of the bit 1 indicates that the 2nd channel queue in the channel 1 and the 2nd channel queue in the channel 2 are in the readable state/non-readable state.

Based on the solution shown in the above-mentioned examples, in an example, acquiring a read command in a channel queue in the readable state among the N channel queues includes: reading numerical values of N bits in the readable state register; and reading the read command from the channel queue corresponding to the bit, whose numerical value is the first numerical value, among the N bits.

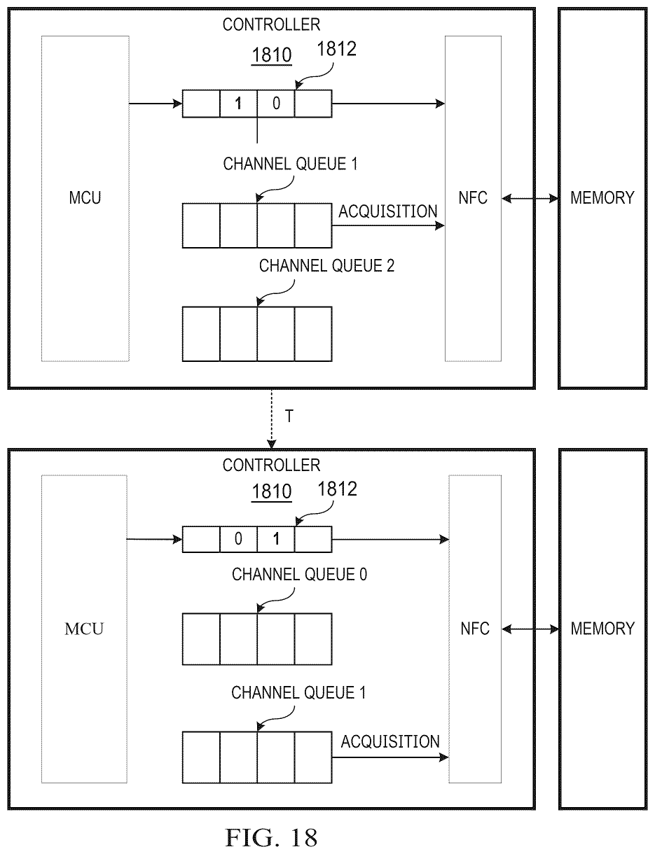

For example, referring to FIG. 18, it shows a schematic diagram of a read command acquisition involved in examples of the present application. As shown in FIG. 18, a micro-controller unit (MCU) in the controller 1810 may add the read command sent by a host to the corresponding channel queue according to the die where the address is located, assuming that one of the channels has two channel queues (channel queue 1 and channel queue 2).

Within a time period 1, the MCU sets, to 1 (indicating that the corresponding channel queue 1 is in the readable state), a bit in the readable state register 1812 corresponding to the channel queue 1, and sets, to 0 (indicating that the corresponding channel queue 2 is in the non-readable state), a bit in the readable state register corresponding to the channel queue 2. Within the time period 1, a flash control unit of the controller, such as a NAND (NAND gate) flash controller (NFC), may read the bits in the readable state register 1812 corresponding to the channel queue 1 and the channel queue 2, determine the channel queue (e.g., the channel queue 1) of which numerical value is 1 to be in the readable state, acquire the read command from the channel queue 1, and perform a read operation in the corresponding die according to the acquired read command.

Accordingly, after a time duration T, within a time period 2, the MCU sets, to 1, a bit in the readable state register 1812 corresponding to the channel queue 2, and sets, to 0, a bit in the readable state register corresponding to the channel queue 1. Within the time period 2, the flash control unit of the controller may read the bits in the readable state register 1812 corresponding to the channel queue 1 and the channel queue 2, determine the channel queue (e.g., the channel queue 2) of which numerical value is 1 to be in the readable state, acquire the read command from the channel queue 2, and perform a read operation in the corresponding die according to the acquired read command.

Based on the solution shown in the above-mentioned examples, in an example, the readable state register is disposed in a flash control unit of the controller; or the readable state register is disposed outside the flash control unit of the controller.

For example, in the solution shown in FIG. 18, the above-mentioned readable state register 1812 is disposed outside the flash control unit of the controller. For example, the readable state register 1812 may be disposed in one circuit between the MCU and the NFC.

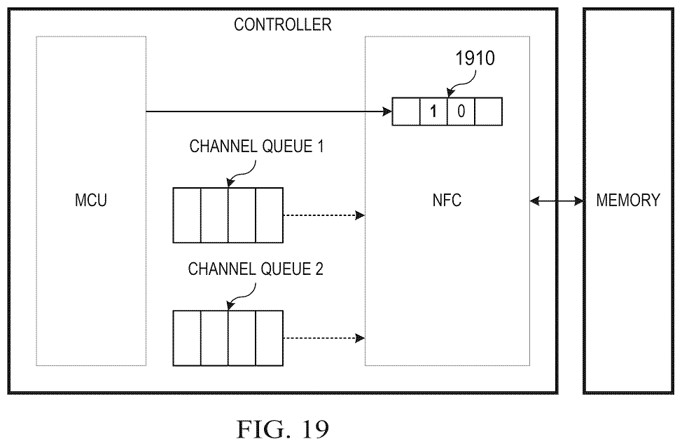

Alternatively, referring to FIG. 19, it shows a schematic diagram of disposing a readable state register involved in examples of the present application. As shown in FIG. 19, the above-mentioned readable state register 1910 may be a register in the NFC. Within each time period, the MCU may set the numerical values of the bits corresponding to various channel queues of each channel in the register inside the NFC, so as to indicate whether the various channel queues are in the readable state or the non-readable state; and accordingly, the NFC reads the numerical values of the bits corresponding to the various channel queues in the internal register to recognize the channel queues in the readable state, and acquires the read commands from the channel queues in the readable state.

The above-mentioned readable state register may be a register already existing in the controller, and the MCU may indicate the corresponding readable state/non-readable state of the various channel queues through part of the bits reserved in the register already existing in the controller.

Alternatively, the above-mentioned readable state register may also be a register newly added in the controller, and the register is dedicated to indicate the corresponding readable state/non-readable state of the various channel queues.

Based on the solution shown in the above-mentioned examples, in an example, a buffer of the controller includes a readable state array, and N fields included in the readable state array correspond to the N channel queues one to one. The operation of, within one time period, setting the third channel queue in the N channel queues to the readable state, and setting other channel queues in the N channel queues other than the third channel queue to the non-readable state includes: setting, to a first numerical value, a field in the readable state array that corresponds to the third channel queue; and setting, to a second numerical value, fields in the readable state register that correspond to other channel queues other than the third channel queue.

The buffer of the above-mentioned controller may be a section of address space in a tightly coupled memory (TCM) or a static random-access memory (SRAM) in a controller.

In the above-mentioned readable state array, each channel may correspond to independent N fields. For example, the channel 1 corresponds to 2 channel queues, and the channel 1 corresponds to a field 0 and a field 1 in the readable state array, where a numerical value of the array 0 indicates that the 1st channel queue in the channel 1 is in the readable state/non-readable state, and a numerical value of the field 1 indicates that the 2nd channel queue in the channel 1 is in the readable state/non-readable state. Accordingly, the channel 2 also corresponds to 2 channel queues, and the channel 2 corresponds to a field 2 and a field 3 in the readable state array, where a numerical value of the field 2 indicates that the 1st channel queue in the channel 2 is in the readable state/non-readable state, and a numerical value of the field 3 indicates that the 2nd channel queue in the channel 2 is in the readable state/non-readable state. In this case, the number of the channel queues corresponding to different channels may be the same or different.

Alternatively, when the memory system includes the plurality of channels, and the number N of the channel queues corresponding to each channel is the same, in the above-mentioned readable state array, the plurality of channels may share the N fields. For example, the channel 1 corresponds to 2 channel queues, and the channel 2 corresponds to 2 channel queues; the field 0 in the readable state array corresponds to the 1st channel queue in the channel 1 and the 1st channel queue in the channel 2. For example, the numerical value of the field 0 indicates that the 1st channel queue in the channel 1 and the 1st channel queue in the channel 2 are in the readable state/non-readable state; and accordingly, the field 1 in the readable state array corresponds to the 2nd channel queue in the channel 1 and the 2nd channel queue in the channel 2. For example, the numerical value of the field 1 indicates that the 2nd channel queue in the channel 1 and the 2nd channel queue in the channel 2 are in the readable state/non-readable state.

Based on the solution shown in the above-mentioned examples, in an example, before setting, to the readable state, part of the N channel queues corresponding to the same channel, the method further includes: receiving a first instruction. The first instruction indicates enabling of a function for setting part of the N channel queues to the readable state.

In the examples of the present application, it may be indicated by the host as to whether the memory system enables a function of setting the plurality of channel queues for one channel, and respectively setting part of the plurality of channel queues to the readable state according to time periods.

For example, in the host, two working modes, which respectively are a normal mode and a high energy efficiency mode, may be set in a management interface of the memory system. When a user selects the high energy efficiency mode in the management interface of the memory system, the host may send a first instruction to the controller, the controller receives the first instruction, then the function of setting part of the N channel queues to the readable state can be enabled, and subsequently, according to the flow shown in the above-mentioned method, part of the plurality of channel queues are respectively set to the readable state according to the time periods. In an example, if the user selects the normal mode later, the host may further send another instruction to the controller to trigger a control to turn off the function of setting part of the N channel queues to the readable state, and the controller subsequently adds the read commands of each channel to the single channel queue corresponding to the channel.

By means of the above-mentioned solution, the host or the user may be allowed to enable or turn off, in a self-defined manner, the function of the memory system for setting part of the N channel queues to the readable state, such that the working flexibility of the memory system is improved.

Based on the solution shown in the above-mentioned examples, in an example, before setting, to the readable state, the N channel queues corresponding to the same channel in turn according to the time periods, the method further includes: receiving a second instruction. The second instruction is for indicating a time duration of the time periods. Setting, to the readable state, the N channel queues corresponding to the same channel in turn according to the time periods includes: according to the time duration of the time periods, setting the N channel queues to the readable state in turn according to the time periods.

In the examples of the present application, the time duration when each channel queue is set to the readable state each time may also be indicated by the host.

For example, in the host, a setting control for switching time durations may be added in the management interface of the memory system (for example, the setting control may be an input box or a select box). The user may set, through the setting control, a time duration of the above-mentioned time periods when each channel queue is set to the readable state each time; after the user completes the setting, the host may send a second instruction to the controller, and the second instruction includes the time duration of the above-mentioned time periods; and after the controller receives the second instruction, the channel queue set to the readable state may be switched according to the time duration indicated by the above-mentioned second instruction.

By means of the above-mentioned solution, the host or the user may be allowed to set the time duration of the time period when each channel queue is set to the readable state each time, such that the working flexibility of the memory system is improved.

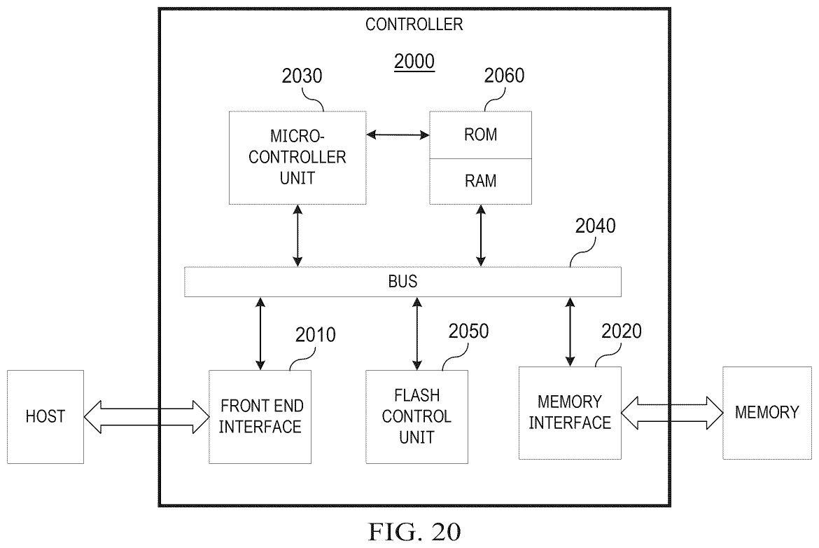

FIG. 20 is a schematic structural diagram of a controller according to an example of the present application. As shown in FIG. 20, the controller 2000 includes a front end interface 2010, a memory interface 2020, a micro-controller unit 2030, a bus 2040, and a flash control unit 2050.

The front end interface 2010 may also be referred to as a Host I/F, is connected to the host, and is configured to communicate with the host.

The memory interface 2020 is connected with a memory (which may be a non-volatile memory), and is configured to convert a data exchange on the bus into a data exchange that conforms to the storage timing of a storage medium.

The micro-controller unit 2030 and the flash control unit 2050 are configured to control functions of the entire controller, control the memory interface 2020 to correctly complete the data exchange between the memory and the bus, and is responsible for managing an interrupt signal, etc. In an example, the micro-controller unit 2030 and the flash control unit 2050 may be configured to implement the control of functions such as data write, data read, garbage collection, wear leveling, error correction, etc.

In an example, the controller 2000 may further include a memory cell 2060. In an example, the memory cell 2060 may include a read-only memory (ROM) and a random access memory (RAM).

The read-only memory may be connected with the micro-controller unit 2030 and the flash control unit 2050, and may be configured to save firmware programs of the controller 2000, fixed configuration information, non-fixed setting data, etc.

The random access memory may be connected with the front end interface 2010, the memory interface 2020, the micro-controller unit 2030, and the flash control unit 2050 through the bus 2040, and may be configured to buffer data exchanged between the controller 2000 and the host or the memory, and buffer data such as partial configuration information of the controller 2000.

The above-mentioned controller 2000 may perform all or part of operations, which are performed by the controller, in the above-mentioned method shown in FIG. 10. The micro-controller unit is configured to set, to a readable state, part of a plurality of channel queues corresponding to a same channel, where the channel queues include read commands received by a controller, addresses comprised in read commands in different channel queues correspond to different memory dies, the readable state indicates that the read commands in the channel queues are allowed to be read, and N is an integer greater than or equal to 2. The flash control unit is configured to acquire a read command in a channel queue in the readable state among the plurality of channel queues; and perform a read operation in a corresponding memory in a memory system according to the acquired read command.

In an example, the addresses comprised in the read commands in the channel queues correspond to dies connected to one or more CE pins in the channel.

In an example, the N channel queues include a first channel queue and a second channel queue; addresses comprised in read commands in the first channel queue correspond to a die connected to a CE pin, whose number belongs to a first number set, in the channel; and addresses comprised in read commands in the second channel queue correspond to a die connected to a CE pin, whose number belongs to a second number set, in the channel.

In an example, the micro-controller unit is configured to set, to the readable state, the N channel queues corresponding to the same channel in turn according to time periods.

In an example, the micro-controller unit is configured to, within one time period, set a third channel queue in the N channel queues to a readable state, and set other channel queues in the N channel queues other than the third channel queue to a non-readable state, where the non-readable state is a state in which the read commands in the channel queues are not allowed to be read; and within two adjacent time periods, the channel queues set to the readable state are different.

In an example, the controller includes a readable state register, and N bits in the readable state register correspond to the N channel queues one to one. The micro-controller unit is configured to set, to a first numerical value, a bit in the readable state register that corresponds to the third channel queue; and set, to a second numerical value, a bit in the readable state register that correspond to other channel queues other than the third channel queue.

In an example, the readable state register is disposed in a flash control unit of the controller; or the readable state register is disposed outside the flash control unit of the controller.

In an example, the flash control unit is configured to read numerical values of N bits in the readable state register; and read the read command from the channel queue corresponding to the bit, whose numerical value is the first numerical value, among the N bits.

In an example, the micro-controller unit is further configured to receive a first instruction sent by a host. The first instruction is for indicating enabling of a function for setting the N channel queues to the readable state in turn according to the time periods.

In an example, the micro-controller unit is further configured to receive a second instruction sent by a host. The second instruction is for indicating a time duration of the time periods. The micro-controller unit is configured to, according to the time duration of the time periods, set the N channel queues to the readable state in turn according to the time periods.

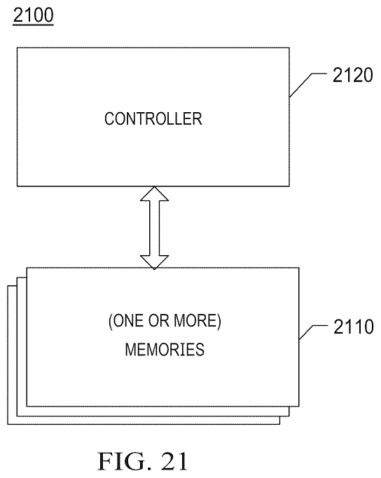

FIG. 21 is a structural block diagram of a memory system according to an example of the present application. As shown in FIG. 21, the memory system 2100 includes: one or more memories 2110; and
a controller 2120 coupled to the memory 2110 and configured to control the memory 2110.

The memory system 2100 may be a mobile phone, a desktop computer, a laptop computer, a tablet computer, a vehicle computer, a gaming console, a printer, a positioning apparatus, a wearable electronic apparatus, a smart sensor, a Virtual Reality (VR) apparatus, an Augmented Reality (AR) apparatus, or all or part of any other suitable electronic apparatus having a memory.

In an example, the memory system 2100 may include a host and a memory sub-system. The memory sub-system is provided with one or more memories 2110 and a controller 2120. The host may be a processor of an electronic apparatus (such as a central processing unit (CPU)) or a system on chip (SoC) (such as an application processor (AP)). The host may be configured to send data to the memory 2110. Alternatively, the host may be configured to receive data from the memory 2110.

According to some implementations, the controller 2120 is further coupled to the host. The controller 2120 may manage data stored in the memory 2110, and communicate with the host.

In some implementations, the controller 2120 is designed for operating in a low duty-cycle environment, such as secure digital (SD) cards, compact flash (CF) Cards, universal serial bus (USB) flash drives, or other media for use in electronic apparatuses, such as personal computers, digital cameras, mobile phones, etc.

In some implementations, the controller 2120 is designed for operating in high duty-cycle environment of solid-state disks (SSD) or embedded multi-media cards (eMMC) used as data memories for mobile apparatuses, such as smartphones, tablets, laptop computers, etc., and enterprise memory arrays.

The controller 2120 may further be configured to control operations of the memory 2110, such as read, erase, and program operations. The controller 2120 may further be configured to manage various functions with respect to data stored or to be stored in the memory 2110, including, but not limited to, bad-block management, garbage collection, logical-to-physical address translation, wear leveling, etc. In some implementations, the controller 2120 is further configured to process error correction codes (ECC) with respect to the data read from or written to the memory 2110.

The controller 2120 may further perform any other suitable functions, such as formatting the memory 2110. The controller 2120 may communicate with an external apparatus according to an example communication protocol.

The controller 2120 and the one or more memories 2110 may be integrated into various types of storage apparatuses, for example, be included in the same package (such as a universal flash storage (UFS) package or an eMMC package). For example, the memory system 2100 may be implemented and packaged into different types of end electronic products.

In an example, the controller 2120 and the single memory 2110 may be integrated into a memory card. The memory card may include a PC card (personal computer memory card international association (PCMCIA)), a CF card, a smart media (SM) card, a memory stick, a multimedia card (MMC, RS-MMC, MMCmicro), an SD card (SD, miniSD, microSD, SDHC), a UFS, etc. The memory card may further include a memory card connector coupling the memory card with the host.

In an example, the controller 2120 and the plurality of memories 2110 may be integrated into a solid state disk (SSD). In some implementations, a storage capacity and/or operation speed of the solid state disk is greater than a storage capacity and/or operation speed of the memory card.

The above-mentioned controller 2120 may be implemented as the controller 2000 shown in FIG. 20.

The above-mentioned controller 2120 may perform all or part of operations, which are performed by the controller, in the above-mentioned solution shown in FIG. 10. The controller 2120 is configured to set, to a readable state, part of a plurality of channel queues corresponding to a same channel, where the channel queues include read commands received by the controller, addresses comprised in read commands in different channel queues correspond to different memory dies, the readable state indicates that the read commands in the channel queues are allowed to be read, and N is an integer greater than or equal to 2. The controller 2120 is further configured to acquire a read command in a channel queue in the readable state among the plurality of channel queues; and perform a read operation in the corresponding memory according to the acquired read commands.

In an example, the addresses comprised in the read commands in the channel queues correspond to dies connected to one or more CE pins in the channel.

In an example, the N channel queues include a first channel queue and a second channel queue; addresses comprised in read commands in the first channel queue correspond to a die connected to a CE pin, whose number belongs to a first number set, in the channel; and addresses comprised in read commands in the second channel queue correspond to a die connected to a CE pin, whose number belongs to a second number set, in the channel.

In an example, the controller 2120 is configured to set, to the readable state, the N channel queues corresponding to the same channel in turn according to time periods.

In an example, the controller 2120 is configured to, within one time period, set a third channel queue in the N channel queues to a readable state, and set other channel queues in the N channel queues other than the third channel queue to a non-readable state, where the non-readable state is a state in which the read commands in the channel queues are not allowed to be read; and within two adjacent time periods, the channel queues set to the readable state are different.

In an example, the controller includes a readable state register, and N bits in the readable state register correspond to the N channel queues one to one. The controller 2120 is configured to set, to a first numerical value, a bit in the readable state register that corresponds to the third channel queue; and set, to a second numerical value, bits in the readable state register that correspond to other channel queues other than the third channel queue.

In an example, the readable state register is disposed in a flash control unit of the controller; or the readable state register is disposed outside the flash control unit of the controller.

In an example, the controller 2120 is configured to read numerical values of N bits in the readable state register; and read the read command from the channel queue corresponding to the bit, whose numerical value is the first numerical value, among the N bits.

In an example, the controller 2120 is further configured to receive a first instruction sent by a host. The first instruction is for indicating enabling of a function for setting the N channel queues to the readable state in turn according to the time periods.

In an example, the controller 2120 is further configured to receive a second instruction sent by a host. The second instruction is for indicating a time duration of the time periods. The controller 2120 is configured to, according to the time duration of the time periods, set the N channel queues to the readable state in turn according to the time periods.

Examples of the present application provide a computer-readable storage medium. The computer-readable storage medium stores an instruction. The instruction, when being run on a control logic circuit (e.g., the above-mentioned micro-controller unit and flash control unit) of a controller, implements the operation method of a memory system provided by the example shown in FIG. 10. In an example, the controller may be the controller shown in FIG. 20, and the memory system may be the memory system shown in FIG. 21.

In the present application, the terms “first” and “second” are for descriptive purposes only, and cannot be construed as indicating or implying relative importance. The term “at least one” means one or more, and the term “a plurality of” means two or more, unless otherwise defined clearly.

The term “and/or” in the present application is merely an association relationship describing related objects, which means that there may be three relationships. For example, A and/or B may indicate three cases: A alone exists, both A and B exist, and B alone exists. In addition, the character “/” herein generally indicates that the related objects are in an “or” relationship.

The above are only examples of the present application, and are not used to limit the present application. Any modifications, equivalent replacements and improvements and the like made within the spirit and principle of the disclosure shall be included within the scope of protection of the present application.

What is claimed is:

1. An operation method of a memory system, comprising:
setting, to a readable state, part of N channel queues corresponding to a same channel, wherein the N channel queues comprise read commands received by a controller, addresses comprised in the read commands in different channel queues correspond to different memory dies, the readable state indicates that the read commands in a corresponding channel queue are allowed to be read, and N is an integer greater than or equal to 2;
acquiring a read command in a channel queue in the readable state among the N channel queues; and
performing a read operation in a corresponding memory in the memory system according to the acquired read command.

2. The method of claim 1, wherein the addresses comprised in the read commands correspond to dies connected to one or more CE pins in the channel.

3. The method of claim 2, wherein the N channel queues comprise a first channel queue and a second channel queue;
addresses comprised in read commands in the first channel queue correspond to a die connected to a CE pin, whose number belongs to a first number set, in the channel; and
addresses comprised in read commands in the second channel queue correspond to a die connected to a CE pin, whose number belongs to a second number set, in the channel.

4. The method of claim 1, wherein setting, to the readable state, the part of the N channel queues corresponding to the same channel comprises:
setting, to the readable state, the N channel queues corresponding to the same channel in turn according to time periods.

5. The method of claim 4, wherein setting, to the readable state, the N channel queues corresponding to the same channel in turn according to the time periods comprises:
within one of the time periods, setting a third channel queue of the N channel queues to a readable state, and setting other channel queues of the N channel queues other than the third channel queue to a non-readable state, wherein the non-readable state indicates that the read commands in corresponding channel queues are not allowed to be read, and wherein within two adjacent time periods, the channel queues set to the readable state are different.

6. The method of claim 5, wherein the controller comprises a readable state register, and N bits in the readable state register correspond to the N channel queues one to one; and
within one of the time periods, setting the third channel queue of the N channel queues to the readable state, and setting other channel queues of the N channel queues other than the third channel queue to the non-readable state comprises:
setting, to a first numerical value, a bit in the readable state register that corresponds to the third channel queue; and
setting, to a second numerical value, bits in the readable state register that correspond to other channel queues other than the third channel queue.

7. The method of claim 6, wherein
the readable state register is disposed in a flash control unit of the controller; or
the readable state register is disposed outside the flash control unit of the controller.

8. The method of claim 6, wherein acquiring the read command in the channel queue in the readable state among the N channel queues comprises:
reading numerical values of the N bits in the readable state register; and
reading the read command from the channel queue corresponding to the bit, whose numerical value is the first numerical value, among the N bits.

9. The method of claim 1, wherein before setting, to the readable state, the part of the N channel queues corresponding to the same channel, the method further comprises:
receiving a first instruction, wherein the first instruction indicates enabling of a function to set the part of the N channel queues to the readable state.

10. The method of claim 4, wherein before setting, to the readable state, the N channel queues corresponding to the same channel in turn according to the time periods, the method further comprises:
receiving a second instruction, wherein the second instruction indicates a time duration of the time periods; and
setting, to the readable state, the N channel queues corresponding to the same channel in turn according to the time periods comprises:
according to the time duration of the time periods, setting the N channel queues to the readable state in turn according to the time periods.

11. A memory system, comprising:
a memory; and
a controller, configured to:
set, to a readable state, part of N channel queues corresponding to a same channel, wherein the N channel queues comprise read commands received by the controller, addresses comprised in the read commands in different channel queues correspond to different memory dies, the readable state indicates that the read commands in corresponding channel queue are allowed to be read, and N is an integer greater than or equal to 2;
acquire a read command in a channel queue in the readable state among the N channel queues; and
perform a read operation in a corresponding memory according to the acquired read commands.

12. The memory system of claim 11, wherein the addresses comprised in the read commands correspond to dies connected to one or more CE pins in the channel.

13. The memory system of claim 12, wherein the N channel queues comprise a first channel queue and a second channel queue;
addresses comprised in read commands in the first channel queue correspond to a die connected to a CE pin, whose number belongs to a first number set, in the channel; and
addresses comprised in read commands in the second channel queue correspond to a die connected to a CE pin, whose number belongs to a second number set, in the channel.

14. The memory system of claim 11, wherein the controller is configured to set, to the readable state, the N channel queues corresponding to the same channel in turn according to time periods.

15. The memory system of claim 14, wherein the controller is configured to, within one of the time periods, set a third channel queue of the N channel queues to a readable state, and set other channel queues of the N channel queues other than the third channel queue to a non-readable state, wherein the non-readable state indicates that the read commands in corresponding channel queues are not allowed to be read; and
within two adjacent time periods, the channel queues set to the readable state are different.

16. The memory system of claim 15, wherein the controller comprises a readable state register, and N bits in the readable state register correspond to the N channel queues one to one; and
the controller is configured to set, to a first numerical value, a bit in the readable state register that corresponds to the third channel queue; and set, to a second numerical value, bits in the readable state register that correspond to other channel queues other than the third channel queue.

17. The memory system of claim 16, wherein
the readable state register is disposed in a flash control unit of the controller; or
the readable state register is disposed outside the flash control unit of the controller.

18. The memory system of claim 16, wherein the controller is configured to read numerical values of the N bits in the readable state register; and read the read command from the channel queue corresponding to the bit, whose numerical value is the first numerical value, among the N bits.

19. The memory system of claim 11, wherein
the controller is further configured to receive a first instruction sent by a host, wherein the first instruction indicates enabling of a function to set the N channel queues to the readable state in turn according to time periods.

20. A computer-readable storage medium, having instructions stored therein, wherein the instructions, when running on a controller in a memory system, implement an operation method of a memory system, the operation method comprising:
setting, to a readable state, part of N channel queues corresponding to a same channel, wherein the N channel queues comprise read commands received by a controller, addresses comprised in the read commands in different channel queues correspond to different memory dies, the readable state indicates that the read commands in corresponding channel queue are allowed to be read, and N is an integer greater than or equal to 2;
acquiring a read command in a channel queue in the readable state among the N channel queues; and
performing a read operation in a corresponding memory in the memory system according to the acquired read command.
